(19) United States
(12) Patent Application Publication
(10) Pub. No.: US 2021/0103337 A1
(43) Pub. Date: Apr. 8, 2021

(54) Facilitating User-Proficiency in Using Radar Gestures to Interact with an Electronic Device

(71) Applicant: Google LLC, Mountain View, CA (US)

(72) Inventors: Daniel Per Jeppsson, Palo Alto, CA (US); Vignesh Sachidanandam, Redwood City, CA (US); Lauren Marie Bedal, San Francisco, CA (US); Morgwn Quin McCarty, Menlo Park, CA (US); Brandon Charles Barbello, Mountain View, CA (US); Alexander Lee, San Francisco, CA (US); Leonardo Giusti, San Francisco, CA (US)

(73) Assignee: Google LLC, Mountain View, CA (US)

(21) Appl. No.: 16/601,452

(22) Filed: Oct. 14, 2019

Related U.S. Application Data
(60) Provisional application No. 62/910,135, filed on Oct. 3, 2019.

(51) Int. Cl. G06F 3/01; G01S 7/02; G06K 9/00

(52) U.S. Cl. CPC G06F 3/017; G01S 7/02; G06F 3/041; G06K 9/00355; G06F 3/016

(57) ABSTRACT

This document describes techniques that enable facilitating user-proficiency in using radar gestures to interact with an electronic device. Using the described techniques, an electronic device can employ a radar system to detect and determine radar-based touch-independent gestures (radar gestures) that are made by the user to interact with the electronic device and applications running on the electronic device. For the radar gestures to be used to control or interact with the electronic device, the user must properly perform the radar gestures. The described techniques therefore also provide a game or tutorial environment that allows the user to learn and practice radar gestures in a natural way. The game or tutorial environments also provide visual gaming elements that give the user feedback when radar gestures are properly made and when the radar gestures are not properly made, which makes the learning and practicing a pleasant and enjoyable experience for the user.

### PRIORITY APPLICATION

This application claims priority under 35 U.S.C. § 119(e) to U.S. Provisional Patent Application No. 62/910,135 filed Oct. 3, 2019 entitled “Facilitating User-Proficiency in Using Radar Gestures to Interact with an Electronic Device”, the disclosure of which is incorporated in its entirety by reference herein.

### BACKGROUND

Smartphones, wearable computers, tablets, and other electronic devices are relied upon for both personal and business use. Users communicate with them via voice and touch and treat them like a virtual assistant to schedule meetings and events, consume digital media, and share presentations and other documents. Further, machine-learning techniques can help these devices to anticipate some of their users' preferences for using the devices. For all this computing power and artificial intelligence, however, these devices are still reactive communicators. That is, however “smart” a smartphone is, and however much the user talks to it like it is a person, the electronic device can only perform tasks and provide feedback after the user interacts with the device. The user may interact with the electronic device in many ways, including voice, touch, and other input techniques. As new technical capabilities and features are introduced, the user may have to learn a new input technique or a different way to use an existing input technique. Only after learning these new techniques and methods can the user take advantage of the new features, applications, and functionality that are available. Lack of experience with the new features and input methods often leads to a poor user experience with the device.

### SUMMARY

This document describes techniques and systems that enable facilitating user-proficiency in using radar gestures to interact with an electronic device. The techniques and systems use a radar field to enable an electronic device to accurately determine the presence or absence of a user near the electronic device and to detect a reach or other radar gesture the user makes to interact with the electronic device. Further, the electronic device includes an application that can help the user learn how to properly make the radar gestures that can be used to interact with the electronic device. The application can be a game, a tutorial, or another format that allows users to learn how to make radar gestures that are effective to interact with or control the electronic device. The application can also use machine-learning techniques and models to help the radar system and electronic device better recognize how different users make radar gestures. The application and machine-learning functionality can improve the user's proficiency in using radar gestures and allow the user to take advantage of the additional functionality and features provided by the availability of the radar gesture, which can result in a better user experience.

Aspects described below include a method performed by a radar-gesture-enabled electronic device. The method includes presenting a first visual gaming element on a display of the radar-gesture-enabled electronic device. The method also includes receiving first radar data corresponding to a first movement of a user in a radar field provided by a radar system, the radar system included or associated with the radar-gesture-enabled electronic device. The method includes determining, based on the first radar data, whether the first movement of the user in the radar field comprises a first radar gesture. The method further includes, in response to determining that the first movement of the user in the radar field comprises the first radar gesture, presenting a successful visual animation of the first visual gaming element, the successful visual animation of the first visual gaming element indicating a successful advance of the visual game-play. Alternately, the method includes, in response to determining that the first movement of the user in the radar field does not comprise the first radar gesture, presenting an unsuccessful visual animation of the first visual gaming element, the unsuccessful visual animation of the first visual element indicating a failure to advance the visual game-play.

Other aspects described below include a radar-gesture-enabled electronic device comprising a radar system, a computer processor, and a computer-readable media. The radar system is implemented at least partially in hardware and provides a radar field. The radar system also senses reflections from a user in the radar field, analyzes the reflections from the user in the radar field, and provides radar data based on the analysis of the reflections. The computer-readable media includes stored instructions that can be executed by the one or more computer processors to implement a gesture-training module. The gesture-training module presents, in context of visual game-play, a first visual gaming element on a display of the radar-gesture-enabled electronic device. The gesture-training module also receives a first subset of the radar data which corresponds to a first movement of the user in the radar field. The gesture-training module further determines, based on the first subset of the radar data, whether the first movement of the user in the radar field comprises a first radar gesture. In response to a determination that the first movement of the user in the radar field comprises the first radar gesture, the gesture-training module presents a successful visual animation of the first visual gaming element, the successful visual animation of the first visual gaming element indicating a successful advance of the visual game-play. Alternately, in response to a determination that the first movement of the user in the radar field does not comprise the first radar gesture, the gesture-training module presents an unsuccessful visual animation of the first visual gaming element, the unsuccessful visual animation of the first visual element indicating a failure to advance the visual game-play.

In other aspects, a radar-gesture-enabled electronic device comprising a radar system, a computer processor, and a computer-readable media is described. The radar system is implemented at least partially in hardware and provides a radar field. The radar system also senses reflections from a user in the radar field, analyzes the reflections from the user in the radar field, and provides radar data based on the analysis of the reflections. The radar-gesture-enabled electronic device includes means for presenting, in context of visual game-play, a first visual gaming element on a display of the radar-gesture-enabled electronic device. The radar-gesture-enabled electronic device also includes means for receiving a first subset of the radar data which corresponds to a first movement of the user in the radar field. The radar-gesture-enabled electronic device also includes means for determining, based on the first subset of the radar data, whether the first movement of the user in the radar field comprises a first radar gesture. The radar-gesture-enabled electronic device also includes means for presenting, in response to a determination that the first movement of the user in the radar field comprises the first radar gesture, a successful visual animation of the first visual gaming element, the successful visual animation of the first visual gaming element indicating a successful advance of the visual game-play. Alternately, the radar-gesture-enabled electronic device includes means for presenting, in response to a determination that the first movement of the user in the radar field does not comprise the first radar gesture, an unsuccessful visual animation of the first visual gaming element, the unsuccessful visual animation of the first visual element indicating a failure to advance the visual game-play.

This summary is provided to introduce simplified concepts of facilitating user-proficiency in using radar gestures to interact with an electronic device. The simplified concepts are further described below in the Detailed Description. This summary is not intended to identify essential features of the claimed subject matter, nor is it intended for use in determining the scope of the claimed subject matter.

### BRIEF DESCRIPTION OF THE DRAWINGS

Aspects of facilitating user-proficiency in using radar gestures to interact with an electronic device are described with reference to the following drawings. The same numbers are used throughout the drawings to reference like features and components:

FIG. 1 illustrates an example operating environment in which techniques that enable facilitating user-proficiency in using radar gestures to interact with an electronic device can be implemented.

FIG. 2 illustrates an example implementation of facilitating user-proficiency in using radar gestures to interact with an electronic device in the example operating environment of FIG. 1.

FIG. 3 illustrates another example implementation of facilitating user-proficiency in using radar gestures to interact with an electronic device in the example operating environment of FIG. 1.

FIG. 4 illustrates an example implementation of an electronic device, including a radar system, through which facilitating user-proficiency in using radar gestures to interact with an electronic device can be implemented.

FIG. 5 illustrates an example implementation of the radar system of FIGS. 1 and 4.

FIG. 6 illustrates example arrangements of receiving antenna elements for the radar system of FIG. 5.

FIG. 7 illustrates additional details of an example implementation of the radar system of FIGS. 1 and 4.

FIG. 8 illustrates an example scheme that can be implemented by the radar system of FIGS. 1 and 4.

FIG. 9 illustrates an example method that uses a tutorial environment with visual elements and visual feedback elements for facilitating user-proficiency in using radar gestures to interact with an electronic device.

FIGS. 10-22 illustrate examples of the visual elements and visual feedback elements used with the tutorial environment methods described in FIG. 9.

FIG. 23 illustrates another example method that uses a game environment that includes visual gaming elements and animations of the visual gaming elements for facilitating user-proficiency in using radar gestures to interact with an electronic device.

FIGS. 24-33 illustrate examples of the visual gaming elements and the animations of the visual gaming elements used with the gaming environment methods described in FIG. 23.

FIG. 34 illustrates an example computing system that can be implemented as any type of client, server, and/or electronic device as described with reference to FIGS. 1-33 to implement, or in which techniques may be implemented that enable, facilitating user-proficiency in using radar gestures to interact with an electronic device.

### DETAILED DESCRIPTION

Overview

This document describes techniques and systems that enable facilitating user-proficiency in using radar gestures to interact with an electronic device. The described techniques employ a radar system that detects and determines radar-based touch-independent gestures (radar gestures) that are made by the user to interact with the electronic device and applications or programs running on the electronic device. In order for the radar gestures to be used to control or interact with the electronic device, the user must properly make or perform the individual radar gestures (otherwise, there is a risk of radar gestures being ignored or of non-gestures being detected as gestures). The described techniques therefore also use an application that can present a tutorial or game environment that allows the user to learn and practice radar gestures in a natural way. The tutorial or game environments also provide visual feedback elements that give the user feedback when radar gestures are properly made and when the radar gestures are not properly made, which makes the learning and practicing a pleasant and enjoyable experience for the user.

In this description, the terms “radar-based touch-independent gesture,” “3D gesture,” or “radar gesture” refer to the nature of a gesture in space, away from the electronic device (e.g., the gesture does not require the user to touch the device, though the gesture does not preclude touch). The radar gesture itself may often only have an active informational component that lies in two dimensions, such as a radar gesture consisting of an upper-left-to-lower-right swipe in a plane, but because the radar gesture also has a distance from the electronic device (a “third” dimension or depth), the radar gestures discussed herein can be generally be considered three-dimensional. Applications that can receive control input through radar-based touch-independent gestures are referred to as radar-gesture applications or radar-enabled applications.

Consider an example smartphone that includes the described radar system and tutorial (or game) application. In this example, the user launches the tutorial or game and interacts with elements presented on a display of the electronic device. The user interacts with the elements or plays the game, which requires the user to make radar gestures. When the user properly makes the radar gesture, the tutorial advances or game-play is extended (or progresses). When the user makes the radar gesture improperly, the application provides other feedback to help the user make the gesture. The radar gesture is determined to be successful (e.g., properly made) based on various criteria that may change depending on factors such as the type of radar-gesture application the gesture is to be used with or the type of radar gesture (e.g., a horizontal swipe, a vertical swipe, or an expanding or contracting pinch). For example, the criteria may include the shape of the radar gesture, the velocity of the radar gesture, or how close the user's hand is to the electronic device during the completion of the radar gesture.

The described techniques and systems employ a radar system, along with other features, to provide a useful and rewarding user experience, including visual feedback and game-play, based on the user's gestures and the operation of a radar-gesture application on the electronic device. Rather than relying only on the user's knowledge and awareness of a particular radar-gesture application, the electronic device can provide feedback to the user to indicate the success or failure of a radar gesture. Some conventional electronic devices may include instructions for using different input methods (e.g., as part of the device packaging or documentation). For example, the electronic device may provide a few diagrams or a website address in a packaging insert. In some cases, the application may also have “help” functionality. The conventional electronic device, however, typically cannot provide a useful and rich ambient experience that can educate the user about the capabilities of the electronic device and the user's interactions with the electronic device.

These are but a few examples of how the described techniques and systems may be used to enable facilitating user-proficiency in using radar gestures to interact with an electronic device, other examples and implementations of which are described throughout this document. The document now turns to an example operating environment, after which example devices, methods, and systems are described.

Operating Environment

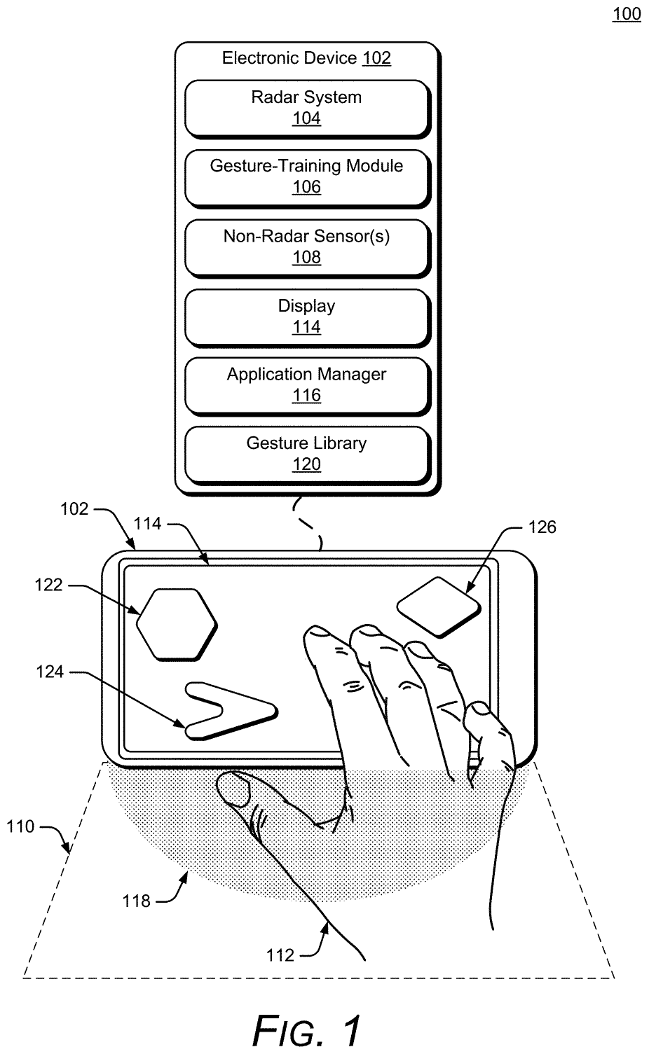

FIG. 1 illustrates an example environment 100 in which techniques that enable facilitating user-proficiency in using radar gestures to interact with an electronic device can be implemented. The example environment 100 includes an electronic device 102, which includes, or is associated with, a persistent radar system 104, a persistent gesture-training module 106 (gesture-training module 106), and, optionally, one or more non-radar sensors 108 (non-radar sensor 108). The term “persistent,” with reference to the radar system 104 or the gesture-training module 106, means that no user interaction is required to activate the radar system 104 (which may operate in various modes, such as a dormant mode, an engaged mode, or an active mode) or the gesture-training module 106. In some implementations, the “persistent” state may be paused or turned off (e.g., by a user). In other implementations, the “persistent” state may be scheduled or otherwise managed in accordance with one or more parameters of the electronic device 102 (or another electronic device). For example, the user may schedule the “persistent” state such that it is only operational during daylight hours, even though the electronic device 102 is on both at night and during the day. The non-radar sensor 108 can be any of a variety of devices, such as an audio sensor (e.g., a microphone), a touch-input sensor (e.g., a touchscreen), a motion sensor, or an image-capture device (e.g., a camera or video-camera).

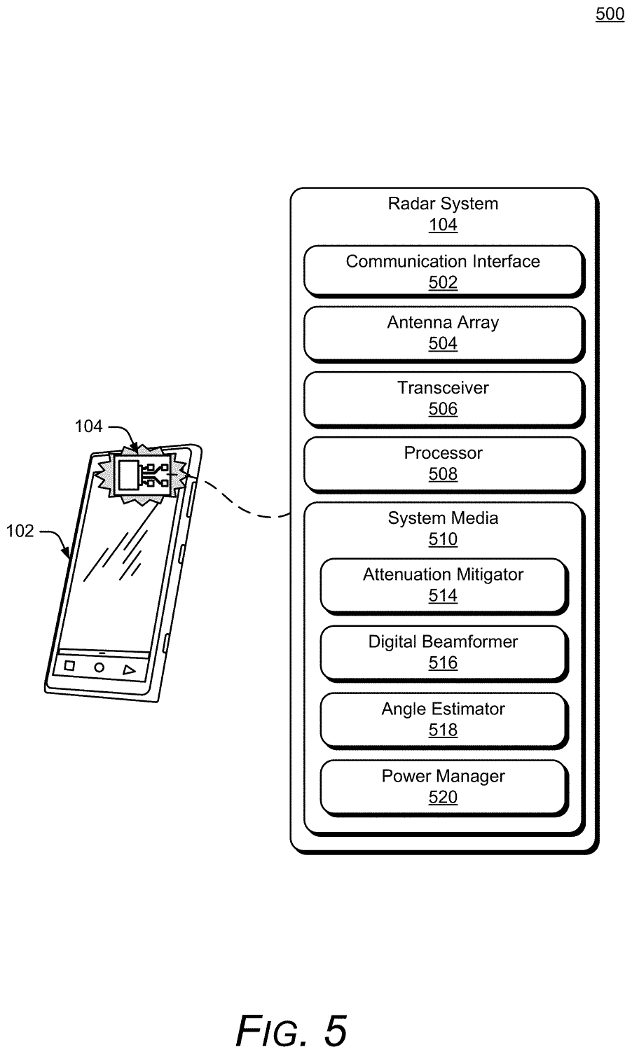

In the example environment 100, the radar system 104 provides a radar field 110 by transmitting one or more radar signals or waveforms as described below with reference to FIGS. 5-8. The radar field 110 is a volume of space from which the radar system 104 can detect reflections of the radar signals and waveforms (e.g., radar signals and waveforms reflected from an object in the volume of space). The radar field 110 may be configured in multiple shapes, such as a sphere, a hemisphere, an ellipsoid, a cone, one or more lobes, or an asymmetric shape (e.g., that can cover an area on either side of an obstruction that is not penetrable by radar). The radar system 104 also enables the electronic device 102, or another electronic device, to sense and analyze reflections from an object or movement in the radar field 110.

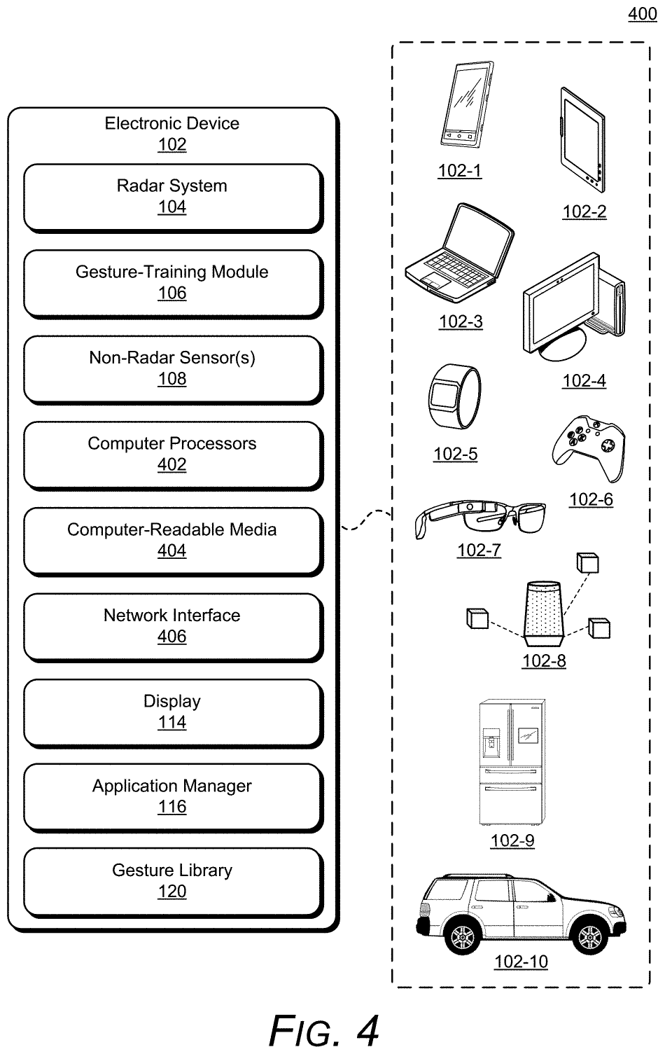

Some implementations of the radar system 104 are particularly advantageous as applied in the context of smartphones, such as the electronic device 102, for which there is a convergence of issues such as a need for low power, a need for processing efficiency, limitations in a spacing and layout of antenna elements, and other issues, and are even further advantageous in the particular context of smartphones for which radar detection of fine hand gestures is desired. Although the implementations are particularly advantageous in the described context of the smartphone for which fine radar-detected hand gestures are required, it is to be appreciated that the applicability of the features and advantages of the present invention is not necessarily so limited, and other implementations involving other types of electronic devices (e.g., as described with reference to FIG. 4) are also within the scope of the present teachings.

With reference to interaction with or by the radar system 104, the object may be any of a variety of objects from which the radar system 104 can sense and analyze radar reflections, such as wood, plastic, metal, fabric, a human body, or a portion of a human body (e.g., a foot, hand, or finger of a user of the electronic device 102). As shown in FIG. 1, the object is a user's hand 112 (user 112). Based on the analysis of the reflections, the radar system 104 can provide radar data that includes various types of information associated with the radar field 110 and the reflections from the user 112 (or a portion of the user 112), as described with reference to FIGS. 5-8 (e.g., the radar system 104 can pass the radar data to other entities, such as the gesture-training module 106).

The radar data can be continuously or periodically provided over time, based on the sensed and analyzed reflections from the object (e.g., the user 112 or the portion of the user 112 in the radar field 110). A position of the user 112 can change over time (e.g., the object in the radar field may move within the radar field 110), and the radar data can thus vary over time corresponding to the changed positions, reflections, and analyses. Because the radar data may vary over time, the radar system 104 provides radar data that includes one or more subsets of radar data that correspond to different periods of time. For example, the radar system 104 can provide a first subset of the radar data corresponding to a first time-period, a second subset of the radar data corresponding to a second time-period, and so forth. In some cases, different subsets of the radar data may overlap, entirely or in part (e.g., one subset of the radar data may include some or all of the same data as another subset of the radar data).

In some implementations, the radar system 104 can provide the radar field 110 such that a field of view (e.g., a volume within which the electronic device 102, the radar system 104, or the gesture-training module 106 can determine radar gestures) includes volumes around the electronic device within approximately one meter of the electronic device 102 and within angles of greater than approximately ten degrees measured from the plane of a display of the electronic device. For example, a gesture can be made approximately one meter from the electronic device 102 and at an angle of approximately ten degrees (as measured from the plane of the display 114). In other words, a field of view of the radar system 104 may include approximately 160 degrees of radar field volume that is approximately normal to a plane or surface of the electronic device.

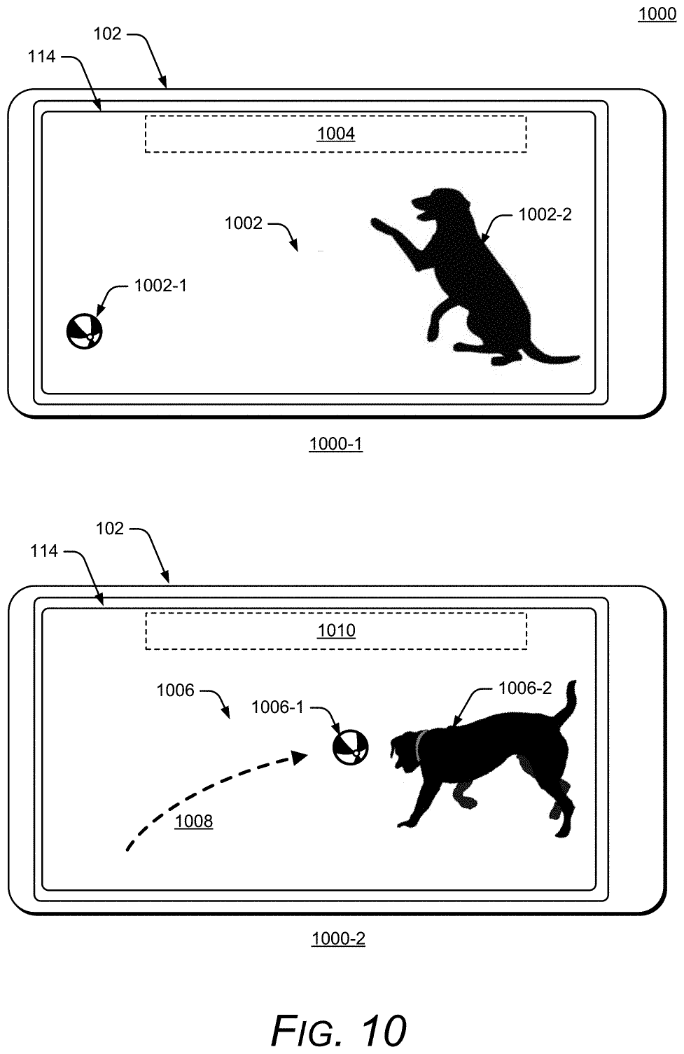

The electronic device 102 can also include a display 114 and an application manager 116. The display 114 can include any suitable display device, such as a touchscreen, a liquid crystal display (LCD), thin film transistor (TFT) LCD, an in-plane switching (IPS) LCD, a capacitive touchscreen display, an organic light-emitting diode (OLED) display, an active-matrix organic light-emitting diode (AMOLED) display, super AMOLED display, and so forth. The display 114 is used to display visual elements that are associated with various modes of the electronic device 102, which are described in further detail with reference to FIGS. 10-33. The application manager 116 can communicate and interact with applications operating on the electronic device 102 to determine and resolve conflicts between applications (e.g., processor resource usage, power usage, or access to other components of the electronic device 102). The application manager 116 can also interact with applications to determine the applications' available input modes, such as touch, voice, or radar gestures (and types of radar gestures), and communicate the available modes to the gesture-training module 106.

The electronic device 102 can detect movements of the user 112 within the radar field 110, such as for radar gesture detection. For instance, the gesture-training module 106 (independently or through the application manager 116) can determine that an application operating on the electronic device has a capability to receive a control input corresponding to a radar gesture (e.g., is a radar-gesture application) and what types of gestures the radar-gesture application can receive. The radar gestures may be based on (or determined through) the radar data and received through the radar system 104. For example, the gesture-training module 106 can present the tutorial or game environment to a user and then the gesture-training module 106 (or the radar system 104) can use one or more subsets of the radar data to detect a motion or movement performed by a portion of the user 112, such as a hand, or an object, that is within a gesture zone 118 of the electronic device 102. The gesture-training module 106 can then determine whether the user's motion is a radar gesture. For example, the electronic device also includes a gesture library 120. The gesture library 120 is a memory device or location that can store data or information related to known radar gestures or radar gesture templates. The gesture-training module 106 can compare radar data that is associated with movements of the user 112 within the gesture zone 118 to the data or information stored in the gesture library 120 to determine whether the movement of the user 112 is a radar gesture. Additional details of the gesture zone 118 and the gesture library 120 are described below.

The gesture zone 118 is a region or volume around the electronic device 102 within which the radar system 104 (or another module or application) can detect a motion by the user or a portion of the user (e.g., the user's hand 112) and determine whether the motion is a radar gesture. The gesture zone of the radar field is a smaller area or region than the radar field (e.g., the gesture zone has a smaller volume than the radar field and is within the radar field). For example, the gesture zone 118 can be a fixed volume around the electronic device that has a static size and/or shape (e.g., a threshold distance around the electronic device 102, such as within three, five, seven, nine, or twelve inches) that is predefined, variable, user-selectable, or determined via another method (e.g., based on power requirements, remaining battery life, imaging/depth sensor, or another factor). In addition to the advantages related to the field of view of the radar system 104, the radar system 104 (and associated programs, module, and managers) allows the electronic device 102 to detect the user's movements and determine radar gestures in lower-light or no-light environments, because the radar system does not need light to operate.

In other cases, the gesture zone 118 may be a volume around the electronic device that is dynamically and automatically adjustable by the electronic device 102, the radar system 104, or the gesture-training module 106, based on factors such as the velocity or location of the electronic device 102, a time of day, a state of an application running on the electronic device 102, or another factor. While the radar system 104 can detect objects within the radar field 110 at greater distances, the gesture zone 118 helps the electronic device 102 and the radar-gesture applications to distinguish between intentional radar gestures by the user and other kinds of motions that may resemble radar gestures, but are not intended as such by the user. The gesture zone 118 may be configured with a threshold distance, such as within approximately three, five, seven, nine, or twelve inches. In some cases, the gesture zone may extend different threshold distances from the electronic device in different directions (e.g., it can have a wedged, oblong, ellipsoid, or asymmetrical shape). The size or shape of the gesture zone can also vary over time or be based on other factors such as a state of the electronic device (e.g., battery level, orientation, locked or unlocked), or an environment (such as in a pocket or purse, in a car, or on a flat surface).

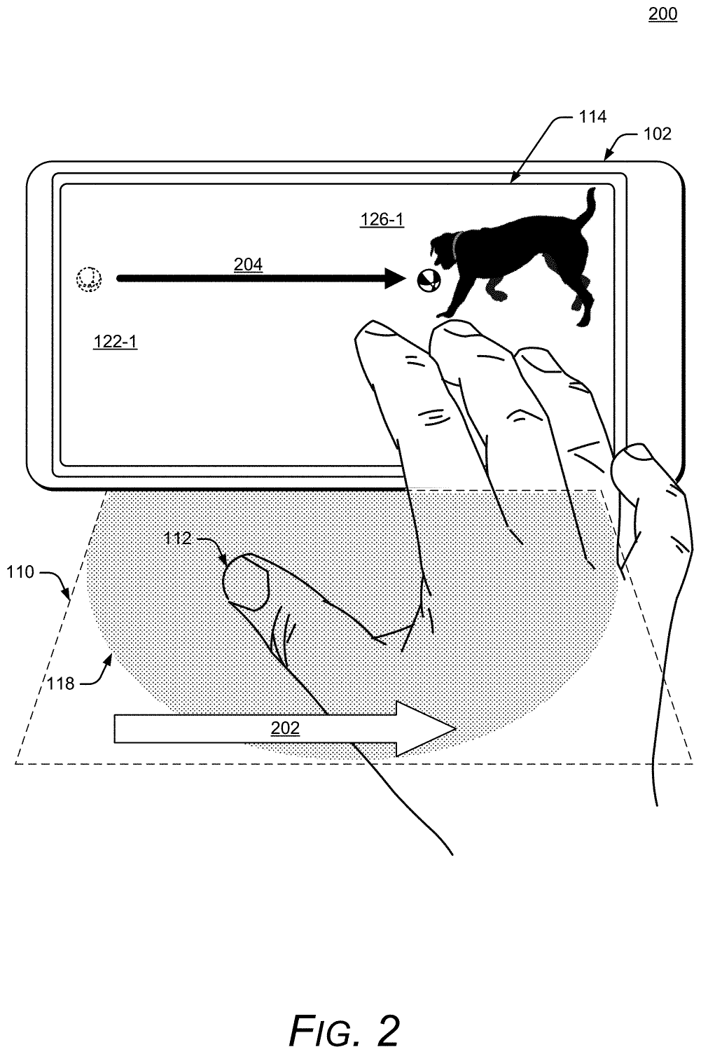

In some implementations, the gesture-training module 106 can be used to provide a tutorial or game environment within which the user 112 can interact with the electronic device 102 using radar gestures, in order to learn and practice making radar gestures. For example, the gesture-training module can present an element on the display 114 that can be used to teach the user how to make and use radar gestures. The element can be any suitable element, such as a visual element, a visual gaming element, or a visual feedback element. FIG. 1 illustrates an example visual element 122, an example visual gaming element 124, and an example visual feedback element 126. For visual brevity in FIG. 1, the examples are represented with generic shapes. These example elements, however, can take any of a variety of forms, such as an abstract shape, a geometric shape, a symbol, a video image (e.g., an embedded video presented on the display 114), or a combination of one or more forms. In other cases, the element can be a real or fictional character, such a person or animal (real or mythological), or a media or game character such as a Pikachu™. Additional examples and details related to these elements are described with reference to FIGS. 2-33.

Consider an example illustrated in FIG. 2, which shows the user 112 within the gesture zone 118. In FIG. 2, an example visual element 122-1 (shown as a ball component and a dog component) is presented on the display 114. In this example, assume that the gesture-training module 106 is presenting the visual element 122-1 to request that the user 112 make a left-to-right swiping radar gesture (e.g., to train the user to make that gesture). Further assume that the visual element 122-1 is initially presented with the ball near a left edge of the display 114, as shown by a dashed-line representation of the ball component, and with the dog waiting near a right edge of the display 114. Continuing the example, the user 112 makes a hand-movement from left to right, as shown by an arrow 202. Assume that the gesture-training module 106 determines that the user's movement is the left-to-right swiping radar gesture. In response to the radar gesture, the gesture-training module 106 can provide an example visual feedback element 126-1 that indicates that the user successfully performed the requested left-to-right radar gesture. For example, the visual feedback element 126-1 can be an animation of the visual element 122-1 in which the ball component of the visual element 122-1 moves toward the dog component of the visual element 122-1 (from left to right) as shown by another arrow 204.

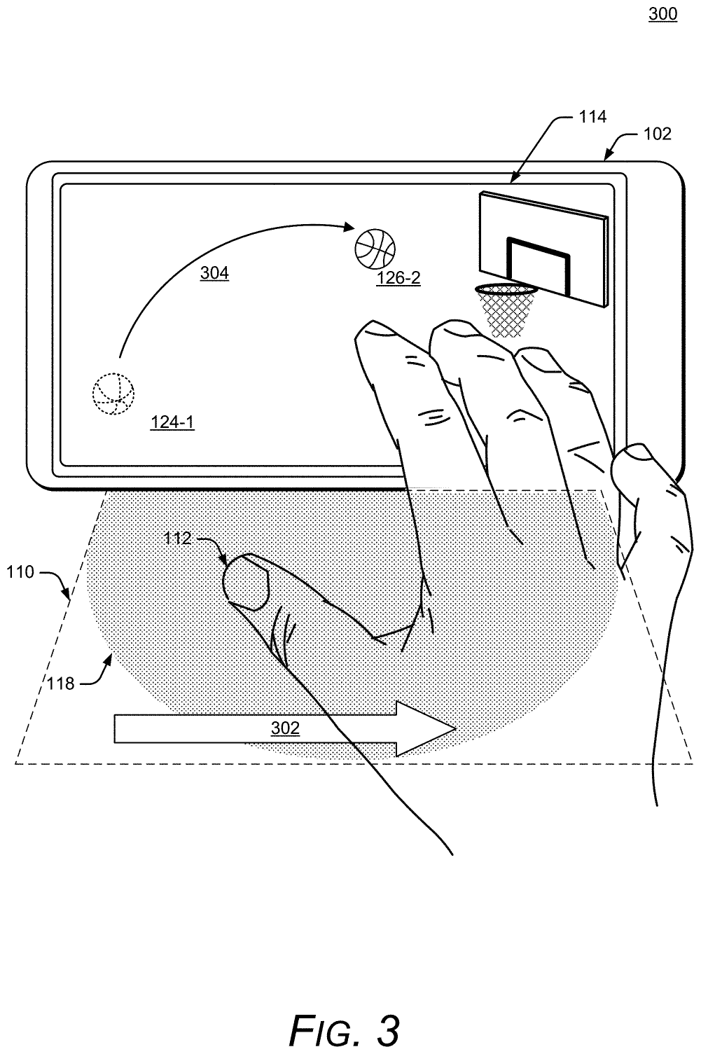

Consider another example illustrated in FIG. 3, which shows the user 112 within the gesture zone 118. In FIG. 3, an example visual gaming element 124-1 (shown as a basketball component and a basket component) is presented on the display 114. In this example, assume that the gesture-training module 106 is presenting the visual gaming element 124-1 to request that the user 112 make a left-to-right swiping radar gesture (e.g., to train the user to make that gesture). Further assume that the visual gaming element 124-1 is initially presented with the basketball component near a left edge of the display 114, as shown by a dashed-line representation of the basketball component, and the basket component is positioned near a right edge of the display 114. Continuing the example, the user 112 makes a hand-movement from left to right, as shown by an arrow 302. Assume that the gesture-training module 106 determines that the user's movement is the left-to-right swiping radar gesture. In response to the radar gesture, the gesture-training module 106 can provide an example visual feedback element 126-2 that indicates that the user successfully performed the requested left-to-right radar gesture. For example, the visual feedback element 126-2 can be a successful animation of the visual gaming element 124-1 in which the basketball component of the visual gaming element 124-1 moves toward the basket component of the visual gaming element 124-1 (from left to right) as shown by another arrow 304.

In either of the above examples 200 or 300, the gesture-training module 106 can also determine that the user's movement is not the requested gesture. In response to the determination that the movement is not the requested radar gesture, the gesture-training module 106 can provide another visual feedback element that indicates that the user did not successfully perform the requested left-to-right radar gesture (not illustrated in FIG. 2 or FIG. 3). Additional examples of the visual elements 122, visual gaming elements 124, and visual feedback elements 126 are described with reference to FIGS. 10-22 and 24-33. These examples show how the described techniques, including the visual elements 122, the visual gaming elements 124, and the visual feedback elements 126 can be used to provide the user with a natural and delightful opportunity to learn and practice radar gestures, which can improve the experience of the user 112 with the electronic device 102 and radar-gesture applications that are running on the electronic device 102.

In more detail, consider FIG. 4, which illustrates an example implementation 400 of the electronic device 102 (including the radar system 104, the gesture-training module 106, the non-radar sensor 108, the display 114, the application manager 116, and the gesture library 120) that can implement aspects of facilitating user-proficiency in using radar gestures to interact with an electronic device. The electronic device 102 of FIG. 4 is illustrated with a variety of example devices, including a smartphone 102-1, a tablet 102-2, a laptop 102-3, a desktop computer 102-4, a computing watch 102-5, a gaming system 102-6, computing spectacles 102-7, a home-automation and control system 102-8, a smart refrigerator 102-9, and an automobile 102-10. The electronic device 102 can also include other devices, such as televisions, entertainment systems, audio systems, drones, track pads, drawing pads, netbooks, e-readers, home security systems, and other home appliances. Note that the electronic device 102 can be a wearable device, a non-wearable but mobile device, or a relatively immobile device (e.g., desktops and appliances). The term “wearable device,” as used in this disclosure, refers to any device that is capable of being worn at, on or in proximity to a person's body, such as a wrist, ankle, waist, chest, or other body part or prosthetic (e.g., watch, bracelet, ring, necklace, other jewelry, eyewear, footwear, glove, headband or other headware, clothing, goggles, contact lens).

In some implementations, exemplary overall lateral dimensions of the electronic device 102 can be approximately eight centimeters by approximately fifteen centimeters. Exemplary footprints of the radar system 104 can be even more limited, such as approximately four millimeters by six millimeters with antennas included. This requirement for such a limited footprint for the radar system 104 is to accommodate the many other desirable features of the electronic device 102 in such a space-limited package (e.g., a fingerprint sensor, the non-radar sensor 108, and so forth). Combined with power and processing limitations, this size requirement can lead to compromises in the accuracy and efficacy of radar-gesture detection, at least some of which can be overcome in view of the teachings herein.

The electronic device 102 also includes one or more computer processors 402 and one or more computer-readable media 404, which includes memory media and storage media. Applications and/or an operating system (not shown) implemented as computer-readable instructions on the computer-readable media 404 can be executed by the computer processors 402 to provide some or all of the functionalities described herein. For example, the processors 402 can be used to execute instructions on the computer-readable media 404 to implement the gesture-training module 106 and/or the application manager 116. The electronic device 102 may also include a network interface 406. The electronic device 102 can use the network interface 406 for communicating data over wired, wireless, or optical networks. By way of example and not limitation, the network interface 406 may communicate data over a local-area-network (LAN), a wireless local-area-network (WLAN), a personal-area-network (PAN), a wide-area-network (WAN), an intranet, the Internet, a peer-to-peer network, point-to-point network, or a mesh network.

Various implementations of the radar system 104 can include a System-on-Chip (SoC), one or more Integrated Circuits (ICs), a processor with embedded processor instructions or configured to access processor instructions stored in memory, hardware with embedded firmware, a printed circuit board with various hardware components, or any combination thereof. The radar system 104 can operate as a monostatic radar by transmitting and receiving its own radar signals.

In some implementations, the radar system 104 may also cooperate with other radar systems 104 that are within an external environment to implement a bistatic radar, a multistatic radar, or a network radar. Constraints or limitations of the electronic device 102, however, may impact a design of the radar system 104. The electronic device 102, for example, may have limited power available to operate the radar, limited computational capability, size constraints, layout restrictions, an exterior housing that attenuates or distorts radar signals, and so forth. The radar system 104 includes several features that enable advanced radar functionality and high performance to be realized in the presence of these constraints, as further described below with respect to FIG. 5. Note that in FIG. 1 and FIG. 4, the radar system 104, the gesture-training module 106, the application manager 116, and the gesture library 120 are illustrated as part of the electronic device 102. In other implementations, one or more of the radar system 104, the gesture-training module 106, the application manager 116, or the gesture library 120 may be separate or remote from the electronic device 102.

These and other capabilities and configurations, as well as ways in which entities of FIG. 1 act and interact, are set forth in greater detail below. These entities may be further divided, combined, and so on. The environment 100 of FIG. 1 and the detailed illustrations of FIG. 2 through FIG. 34 illustrate some of many possible environments and devices capable of employing the described techniques. FIGS. 5-8 describe additional details and features of the radar system 104. In FIGS. 5-8, the radar system 104 is described in the context of the electronic device 102, but as noted above, the applicability of the features and advantages of the described systems and techniques are not necessarily so limited, and other implementations involving other types of electronic devices may also be within the scope of the present teachings.

FIG. 5 illustrates an example implementation 500 of the radar system 104 that can be used to enable facilitating user-proficiency in using radar gestures to interact with an electronic device. In the example 500, the radar system 104 includes at least one of each of the following components: a communication interface 502, an antenna array 504, a transceiver 506, a processor 508, and a system media 510 (e.g., one or more computer-readable storage media). The processor 508 can be implemented as a digital signal processor, a controller, an application processor, another processor (e.g., the computer processor 402 of the electronic device 102), or some combination thereof. The system media 510, which may be included within, or be separate from, the computer-readable media 404 of the electronic device 102, includes one or more of the following modules: an attenuation mitigator 514, a digital beamformer 516, an angle estimator 518, or a power manager 520. These modules can compensate for, or mitigate the effects of, integrating the radar system 104 within the electronic device 102, thereby enabling the radar system 104 to recognize small or complex gestures, distinguish between different orientations of the user, continuously monitor an external environment, or realize a target false-alarm rate. With these features, the radar system 104 can be implemented within a variety of different devices, such as the devices illustrated in FIG. 4.

Using the communication interface 502, the radar system 104 can provide radar data to the gesture-training module 106. The communication interface 502 may be a wireless or wired interface based on the radar system 104 being implemented separate from, or integrated within, the electronic device 102. Depending on the application, the radar data may include raw or minimally processed data, in-phase and quadrature (I/Q) data, range-Doppler data, processed data including target location information (e.g., range, azimuth, elevation), clutter map data, and so forth. Generally, the radar data contains information that is usable by the gesture-training module 106 for facilitating user-proficiency in using radar gestures to interact with an electronic device.

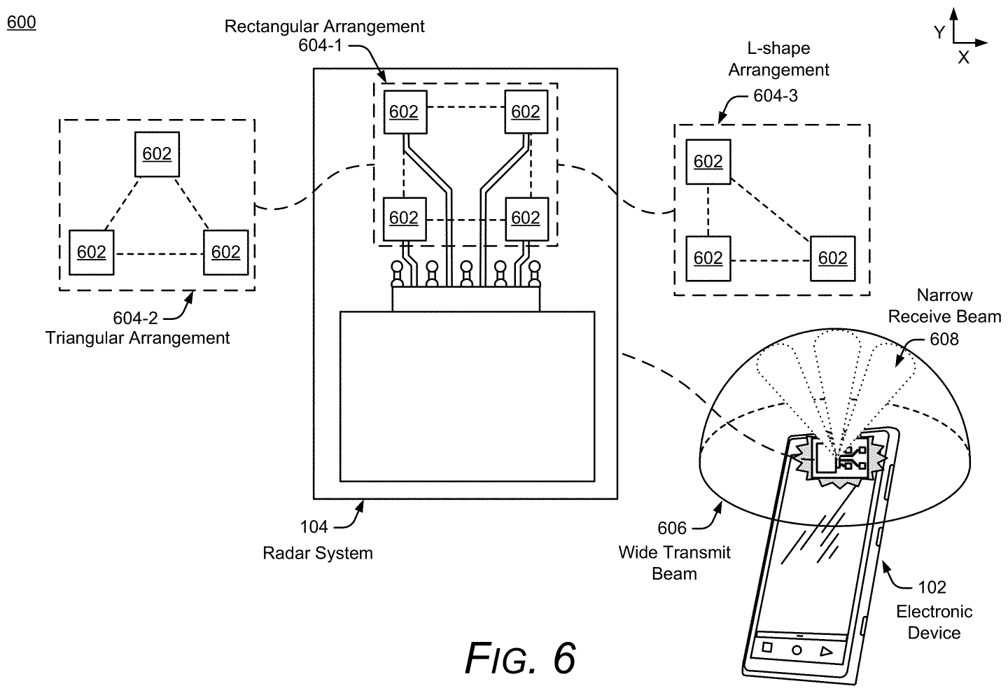

The antenna array 504 includes at least one transmitting antenna element (not shown) and at least two receiving antenna elements (as shown in FIG. 6). In some cases, the antenna array 504 may include multiple transmitting antenna elements to implement a multiple-input multiple-output (MIMO) radar capable of transmitting multiple distinct waveforms at a time (e.g., a different waveform per transmitting antenna element). The use of multiple waveforms can increase a measurement accuracy of the radar system 104. The receiving antenna elements can be positioned in a one-dimensional shape (e.g., a line) or a two-dimensional shape for implementations that include three or more receiving antenna elements. The one-dimensional shape enables the radar system 104 to measure one angular dimension (e.g., an azimuth or an elevation) while the two-dimensional shape enables two angular dimensions to be measured (e.g., both azimuth and elevation). Example two-dimensional arrangements of the receiving antenna elements are further described with respect to FIG. 6.

FIG. 6 illustrates example arrangements 600 of receiving antenna elements 602. If the antenna array 504 includes at least four receiving antenna elements 602, for example, the receiving antenna elements 602 can be arranged in a rectangular arrangement 604-1 as depicted in the middle of FIG. 6. Alternatively, a triangular arrangement 604-2 or an L-shape arrangement 604-3 may be used if the antenna array 504 includes at least three receiving antenna elements 602.

Due to a size or layout constraint of the electronic device 102, an element spacing between the receiving antenna elements 602 or a quantity of the receiving antenna elements 602 may not be ideal for the angles at which the radar system 104 is to monitor. In particular, the element spacing may cause angular ambiguities to be present that make it challenging for conventional radars to estimate an angular position of a target. Conventional radars may therefore limit a field of view (e.g., angles that are to be monitored) to avoid an ambiguous zone, which has the angular ambiguities, and thereby reduce false detections. For example, conventional radars may limit the field of view to angles between approximately −45 degrees to 45 degrees to avoid angular ambiguities that occur using a wavelength of 5 millimeters (mm) and an element spacing of 3.5 mm (e.g., the element spacing being 70% of the wavelength). Consequently, the conventional radar may be unable to detect targets that are beyond the 45-degree limits of the field of view. In contrast, the radar system 104 includes the digital beamformer 516 and the angle estimator 518, which resolve the angular ambiguities and enable the radar system 104 to monitor angles beyond the 45-degree limit, such as angles between approximately −90 degrees to 90 degrees, or up to approximately −180 degrees and 180 degrees. These angular ranges can be applied across one or more directions (e.g., azimuth and/or elevation). Accordingly, the radar system 104 can realize low false-alarm rates for a variety of different antenna array designs, including element spacings that are less than, greater than, or equal to half a center wavelength of the radar signal.

Using the antenna array 504, the radar system 104 can form beams that are steered or un-steered, wide or narrow, or shaped (e.g., as a hemisphere, cube, fan, cone, or cylinder). As an example, the one or more transmitting antenna elements (not shown) may have an un-steered omnidirectional radiation pattern or may be able to produce a wide beam, such as the wide transmit beam 606. Either of these techniques enable the radar system 104 to illuminate a large volume of space. To achieve target angular accuracies and angular resolutions, however, the receiving antenna elements 602 and the digital beamformer 516 can be used to generate thousands of narrow and steered beams (e.g., 2000 beams, 4000 beams, or 6000 beams), such as the narrow receive beam 608. In this way, the radar system 104 can efficiently monitor the external environment and accurately determine arrival angles of reflections within the external environment.

Returning to FIG. 5, the transceiver 506 includes circuitry and logic for transmitting and receiving radar signals via the antenna array 504. Components of the transceiver 506 can include amplifiers, mixers, switches, analog-to-digital converters, filters, and so forth for conditioning the radar signals. The transceiver 506 can also include logic to perform in-phase/quadrature (I/Q) operations, such as modulation or demodulation. The transceiver 506 can be configured for continuous wave radar operations or pulsed radar operations. A variety of modulations can be used to produce the radar signals, including linear frequency modulations, triangular frequency modulations, stepped frequency modulations, or phase modulations.

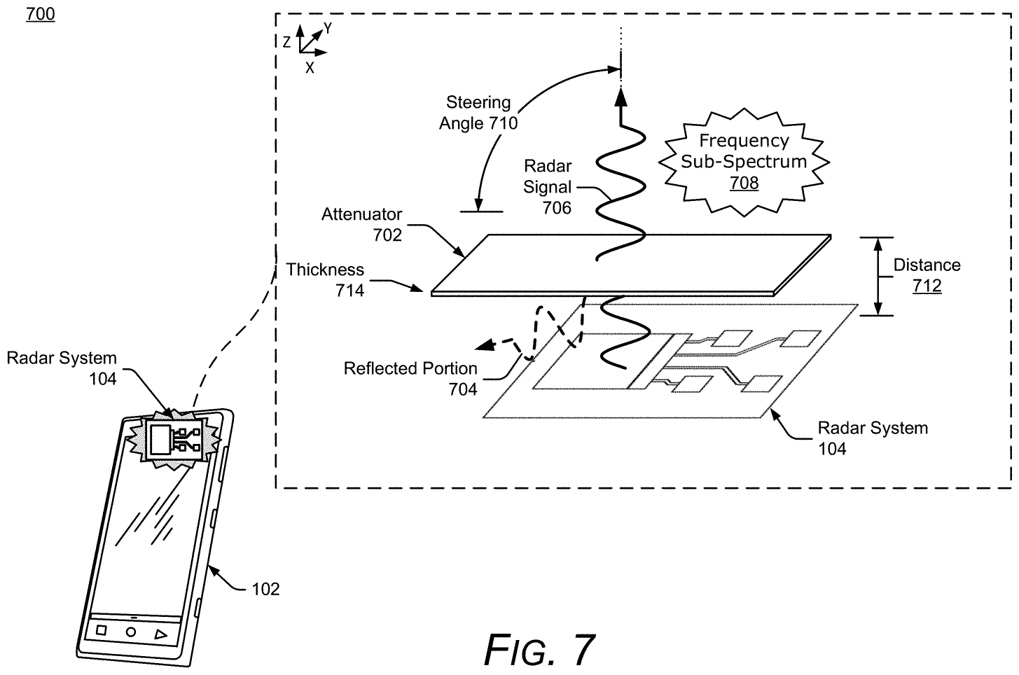

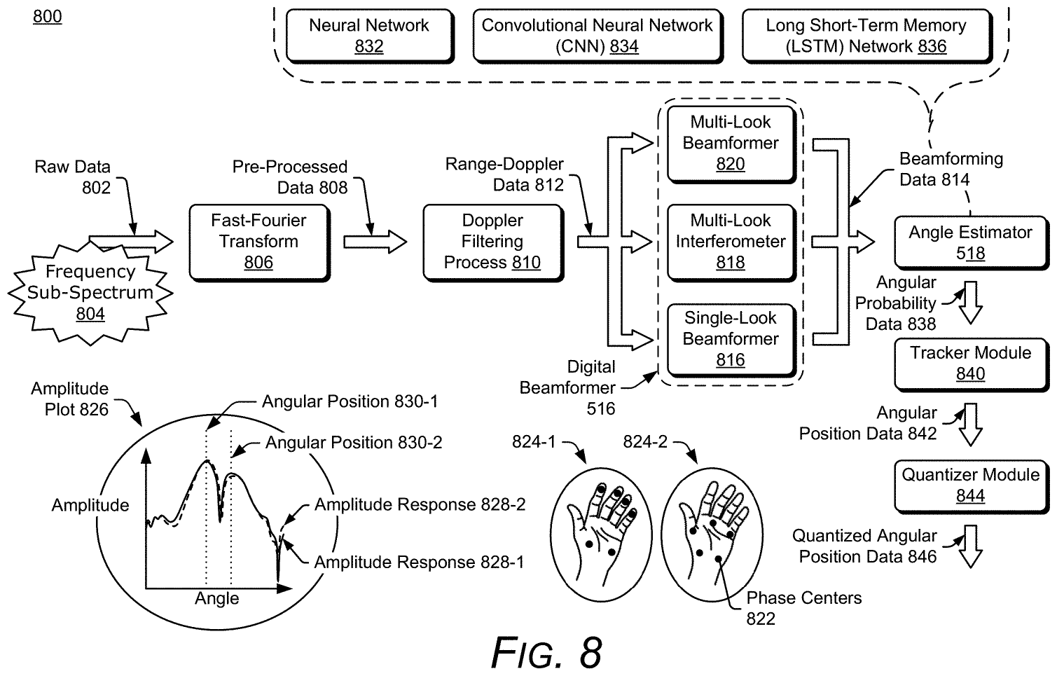

The transceiver 506 can generate radar signals within a range of frequencies (e.g., a frequency spectrum), such as between 1 gigahertz (GHz) and 400 GHz, between 4 GHz and 100 GHz, or between 57 GHz and 63 GHz. The frequency spectrum can be divided into multiple sub-spectra that have a similar bandwidth or different bandwidths. The bandwidths can be on the order of 500 megahertz (MHz), 1 GHz, 2 GHz, and so forth. As an example, different frequency sub-spectra may include frequencies between approximately 57 GHz and 59 GHz, 59 GHz and 61 GHz, or 61 GHz and 63 GHz. Multiple frequency sub-spectra that have a same bandwidth and may be contiguous or non-contiguous may also be chosen for coherence. The multiple frequency sub-spectra can be transmitted simultaneously or separated in time using a single radar signal or multiple radar signals. The contiguous frequency sub-spectra enable the radar signal to have a wider bandwidth while the non-contiguous frequency sub-spectra can further emphasize amplitude and phase differences that enable the angle estimator 518 to resolve angular ambiguities. The attenuation mitigator 514 or the angle estimator 518 may cause the transceiver 506 to utilize one or more frequency sub-spectra to improve performance of the radar system 104, as further described with respect to FIGS. 7 and 8.

A power manager 520 enables the radar system 104 to conserve power internally or externally within the electronic device 102. In some implementations, the power manager 520 communicates with the gesture-training module 106 to conserve power within either or both of the radar system 104 or the electronic device 102. Internally, for example, the power manager 520 can cause the radar system 104 to collect data using a predefined power mode or a specific gesture-frame update rate. The gesture-frame update rate represents how often the radar system 104 actively monitors the external environment by transmitting and receiving one or more radar signals. Generally speaking, the power consumption is proportional to the gesture-frame update rate. As such, higher gesture-frame update rates result in larger amounts of power being consumed by the radar system 104.

Each predefined power mode can be associated with a particular framing structure, a particular transmit power level, or particular hardware (e.g., a low-power processor or a high-power processor). Adjusting one or more of these affects the radar system's 104 power consumption. Reducing power consumption, however, affects performance, such as the gesture-frame update rate and response delay. In this case, the power manager 520 dynamically switches between different power modes such that gesture-frame update rate, response delay and power consumption are managed together based on the activity within the environment. In general, the power manager 520 determines when and how power can be conserved, and incrementally adjusts power consumption to enable the radar system 104 to operate within power limitations of the electronic device 102. In some cases, the power manager 520 may monitor an amount of available power remaining and adjust operations of the radar system 104 accordingly. For example, if the remaining amount of power is low, the power manager 520 may continue operating in a lower-power mode instead of switching to a higher-power mode.

The lower-power mode, for example, may use a lower gesture-frame update rate on the order of a few hertz (e.g., approximately 1 Hz or less than 5 Hz) and consume power on the order of a few milliwatts (mW) (e.g., between approximately 2 mW and 4 mW). The higher-power mode, on the other hand, may use a higher gesture-frame update rate on the order of tens of hertz (Hz) (e.g., approximately 20 Hz or greater than 10 Hz), which causes the radar system 104 to consume power on the order of several milliwatts (e.g., between approximately 6 mW and 20 mW). While the lower-power mode can be used to monitor the external environment or detect an approaching user, the power manager 520 may switch to the higher-power mode if the radar system 104 determines the user is starting to perform a gesture. Different triggers may cause the power manager 520 to dynamically switch between the different power modes. Example triggers include motion or the lack of motion, appearance or disappearance of the user, the user moving into or out of a designated region (e.g., a region defined by range, azimuth, or elevation), a change in velocity of a motion associated with the user, or a change in reflected signal strength (e.g., due to changes in radar cross section). In general, the triggers that indicate a lower probability of the user interacting with the electronic device 102 or a preference to collect data using a longer response delay may cause a lower-power mode to be activated to conserve power.

Each power mode can be associated with a particular framing structure. The framing structure specifies a configuration, scheduling, and signal characteristics associated with the transmission and reception of the radar signals. In general, the framing structure is set up such that the appropriate radar data can be collected based on the external environment. The framing structure can be customized to facilitate collection of different types of radar data for different applications (e.g., proximity detection, feature recognition, or gesture recognition). During inactive times throughout each level of the framing structure, the power-manager 520 can turn off the components within the transceiver 506 in FIG. 5 to conserve power. The framing structure enables power to be conserved through adjustable duty cycles within each frame type. For example, a first duty cycle can be based on a quantity of active feature frames relative to a total quantity of feature frames. A second duty cycle can be based on a quantity of active radar frames relative to a total quantity of radar frames. A third duty cycle can be based on a duration of the radar signal relative to a duration of a radar frame.

Consider an example framing structure (not illustrated) for the lower-power mode that consumes approximately 2 mW of power and has a gesture-frame update rate between approximately 1 Hz and 4 Hz. In this example, the framing structure includes a gesture frame with a duration between approximately 250 ms and 1 second. The gesture frame includes thirty-one pulse-mode feature frames. One of the thirty-one pulse-mode feature frames is in the active state. This results in the duty cycle being approximately equal to 3.2%. A duration of each pulse-mode feature frame is between approximately 8 ms and 32 ms. Each pulse-mode feature frame is composed of eight radar frames. Within the active pulse-mode feature frame, all eight radar frames are in the active state. This results in the duty cycle being equal to 100%. A duration of each radar frame is between approximately 1 ms and 4 ms. An active time within each of the active radar frames is between approximately 32 ρs and 128 ρs. As such, the resulting duty cycle is approximately 3.2%. This example framing structure has been found to yield good performance results. These good performance results are in terms of good gesture recognition and presence detection while also yielding good power efficiency results in the application context of a handheld smartphone in a low-power state. Based on this example framing structure, the power manager 520 can determine a time for which the radar system 104 is not actively collecting radar data. Based on this inactive time period, the power manager 520 can conserve power by adjusting an operational state of the radar system 104 and turning off one or more components of the transceiver 506, as further described below.

The power manager 520 can also conserve power by turning off one or more components within the transceiver 506 (e.g., a voltage-controlled oscillator, a multiplexer, an analog-to-digital converter, a phase lock loop, or a crystal oscillator) during inactive time periods. These inactive time periods occur if the radar system 104 is not actively transmitting or receiving radar signals, which may be on the order of microseconds (μs), milliseconds (ms), or seconds (s). Further, the power manager 520 can modify transmission power of the radar signals by adjusting an amount of amplification provided by a signal amplifier. Additionally, the power manager 520 can control the use of different hardware components within the radar system 104 to conserve power. If the processor 508 comprises a lower-power processor and a higher-power processor (e.g., processors with different amounts of memory and computational capability), for example, the power manager 520 can switch between utilizing the lower-power processor for low-level analysis (e.g., implementing the idle mode, detecting motion, determining a location of a user, or monitoring the environment) and the higher-power processor for situations in which high-fidelity or accurate radar data is requested by the gesture-training module 106 (e.g., for implementing the aware mode, the engaged mode, or the active mode, gesture recognition or user orientation).

Further, the power manager 520 can determine a context of the environment around the electronic device 102. From that context, the power manager 520 can determine which power states are to be made available and how they are configured. For example, if the electronic device 102 is in a user's pocket, then although the user is detected as being proximate to the electronic device 102, there is no need for the radar system 104 to operate in the higher-power mode with a high gesture-frame update rate. Accordingly, the power manager 520 can cause the radar system 104 to remain in the lower-power mode, even though the user is detected as being proximate to the electronic device 102 and cause the display 114 to remain in an off or other lower-power state. The electronic device 102 can determine the context of its environment using any suitable non-radar sensor 108 (e.g., gyroscope, accelerometer, light sensor, proximity sensor, capacitance sensor, and so on) in combination with the radar system 104. The context may include time of day, calendar day, lightness/darkness, number of users near the user, surrounding noise level, speed of movement of surrounding objects (including the user) relative to the electronic device 102, and so forth).

FIG. 7 illustrates additional details of an example implementation 700 of the radar system 104 within the electronic device 102. In the example 700, the antenna array 504 is positioned underneath an exterior housing of the electronic device 102, such as a glass cover or an external case. Depending on its material properties, the exterior housing may act as an attenuator 702, which attenuates or distorts radar signals that are transmitted and received by the radar system 104. The attenuator 702 may include different types of glass or plastics, some of which may be found within display screens, exterior housings, or other components of the electronic device 102 and have a dielectric constant (e.g., relative permittivity) between approximately four and ten. Accordingly, the attenuator 702 is opaque or semi-transparent to a radar signal 706 and may cause a portion of a transmitted or received radar signal 706 to be reflected (as shown by a reflected portion 704). For conventional radars, the attenuator 702 may decrease an effective range that can be monitored, prevent small targets from being detected, or reduce overall accuracy.

Assuming a transmit power of the radar system 104 is limited, and re-designing the exterior housing is not desirable, one or more attenuation-dependent properties of the radar signal 706 (e.g., a frequency sub-spectrum 708 or a steering angle 710) or attenuation-dependent characteristics of the attenuator 702 (e.g., a distance 712 between the attenuator 702 and the radar system 104 or a thickness 714 of the attenuator 702) are adjusted to mitigate the effects of the attenuator 702. Some of these characteristics can be set during manufacturing or adjusted by the attenuation mitigator 514 during operation of the radar system 104. The attenuation mitigator 514, for example, can cause the transceiver 506 to transmit the radar signal 706 using the selected frequency sub-spectrum 708 or the steering angle 710, cause a platform to move the radar system 104 closer or farther from the attenuator 702 to change the distance 712, or prompt the user to apply another attenuator to increase the thickness 714 of the attenuator 702.

Appropriate adjustments can be made by the attenuation mitigator 514 based on pre-determined characteristics of the attenuator 702 (e.g., characteristics stored in the computer-readable media 404 of the electronic device 102 or within the system media 510) or by processing returns of the radar signal 706 to measure one or more characteristics of the attenuator 702. Even if some of the attenuation-dependent characteristics are fixed or constrained, the attenuation mitigator 514 can take these limitations into account to balance each parameter and achieve a target radar performance. As a result, the attenuation mitigator 514 enables the radar system 104 to realize enhanced accuracy and larger effective ranges for detecting and tracking the user that is located on an opposite side of the attenuator 702. These techniques provide alternatives to increasing transmit power, which increases power consumption of the radar system 104, or changing material properties of the attenuator 702, which can be difficult and expensive once a device is in production.

FIG. 8 illustrates an example scheme 800 implemented by the radar system 104. Portions of the scheme 800 may be performed by the processor 508, the computer processors 402, or other hardware circuitry. The scheme 800 can be customized to support different types of electronic devices and radar-based applications (e.g., the gesture-training module 106), and also enables the radar system 104 to achieve target angular accuracies despite design constraints.

The transceiver 506 produces raw data 802 based on individual responses of the receiving antenna elements 602 to a received radar signal. The received radar signal may be associated with one or more frequency sub-spectra 804 that were selected by the angle estimator 518 to facilitate angular ambiguity resolution. The frequency sub-spectra 804, for example, may be chosen to reduce a quantity of sidelobes or reduce an amplitude of the sidelobes (e.g., reduce the amplitude by 0.5 dB, 1 dB, or more). A quantity of frequency sub-spectra can be determined based on a target angular accuracy or computational limitations of the radar system 104.

The raw data 802 contains digital information (e.g., in-phase and quadrature data) for a period of time, different wavenumbers, and multiple channels respectively associated with the receiving antenna elements 602. A Fast-Fourier Transform (FFT) 806 is performed on the raw data 802 to generate pre-processed data 808. The pre-processed data 808 includes digital information across the period of time, for different ranges (e.g., range bins), and for the multiple channels. A Doppler filtering process 810 is performed on the pre-processed data 808 to generate range-Doppler data 812. The Doppler filtering process 810 may comprise another FFT that generates amplitude and phase information for multiple range bins, multiple Doppler frequencies, and for the multiple channels. The digital beamformer 516 produces beamforming data 814 based on the range-Doppler data 812. The beamforming data 814 contains digital information for a set of azimuths and/or elevations, which represents the field of view for which different steering angles or beams are formed by the digital beamformer 516. Although not depicted, the digital beamformer 516 may alternatively generate the beamforming data 814 based on the pre-processed data 808 and the Doppler filtering process 810 may generate the range-Doppler data 812 based on the beamforming data 814. To reduce a quantity of computations, the digital beamformer 516 may process a portion of the range-Doppler data 812 or the pre-processed data 808 based on a range, time, or Doppler frequency interval of interest.

The digital beamformer 516 can be implemented using a single-look beamformer 816, a multi-look interferometer 818, or a multi-look beamformer 820. In general, the single-look beamformer 816 can be used for deterministic objects (e.g., point-source targets having a single-phase center). For non-deterministic targets (e.g., targets having multiple phase centers), the multi-look interferometer 818 or the multi-look beamformer 820 are used to improve accuracies relative to the single-look beamformer 816. Humans are an example of a non-deterministic target and have multiple phase centers 822 that can change based on different aspect angles, as shown at 824-1 and 824-2. Variations in the constructive or destructive interference generated by the multiple phase centers 822 can make it challenging for conventional radars to accurately determine angular positions. The multi-look interferometer 818 or the multi-look beamformer 820, however, perform coherent averaging to increase an accuracy of the beamforming data 814. The multi-look interferometer 818 coherently averages two channels to generate phase information that can be used to accurately determine the angular information. The multi-look beamformer 820, on the other hand, can coherently average two or more channels using linear or non-linear beamformers, such as Fourier, Capon, multiple signal classification (MUSIC), or minimum variance distortion less response (MVDR). The increased accuracies provided via the multi-look beamformer 820 or the multi-look interferometer 818 enable the radar system 104 to recognize small gestures or distinguish between multiple portions of the user.

The angle estimator 518 analyzes the beamforming data 814 to estimate one or more angular positions. The angle estimator 518 may utilize signal-processing techniques, pattern-matching techniques, or machine-learning. The angle estimator 518 also resolves angular ambiguities that may result from a design of the radar system 104 or the field of view the radar system 104 monitors. An example angular ambiguity is shown within an amplitude plot 826 (e.g., amplitude response).

The amplitude plot 826 depicts amplitude differences that can occur for different angular positions of the target and for different steering angles 710. A first amplitude response 828-1 (illustrated with a solid line) is shown for a target positioned at a first angular position 830-1. Likewise, a second amplitude response 828-2 (illustrated with a dotted line) is shown for the target positioned at a second angular position 830-2. In this example, the differences are considered across angles between −180 degrees and 180 degrees.

As shown in the amplitude plot 826, an ambiguous zone exists for the two angular positions 830-1 and 830-2. The first amplitude response 828-1 has a highest peak at the first angular position 830-1 and a lesser peak at the second angular position 830-2. While the highest peak corresponds to the actual position of the target, the lesser peak causes the first angular position 830-1 to be ambiguous because it is within some threshold for which conventional radars may be unable to confidently determine whether the target is at the first angular position 830-1 or the second angular position 830-2. In contrast, the second amplitude response 828-2 has a lesser peak at the second angular position 830-2 and a higher peak at the first angular position 830-1. In this case, the lesser peak corresponds to the target's location.

While conventional radars may be limited to using a highest peak amplitude to determine the angular positions, the angle estimator 518 instead analyzes subtle differences in shapes of the amplitude responses 828-1 and 828-2. Characteristics of the shapes can include, for example, roll-offs, peak or null widths, an angular location of the peaks or nulls, a height or depth of the peaks and nulls, shapes of sidelobes, symmetry within the amplitude response 828-1 or 828-2, or the lack of symmetry within the amplitude response 828-1 or 828-2. Similar shape characteristics can be analyzed in a phase response, which can provide additional information for resolving the angular ambiguity. The angle estimator 518 therefore maps the unique angular signature or pattern to an angular position.

The angle estimator 518 can include a suite of algorithms or tools that can be selected according to the type of electronic device 102 (e.g., computational capability or power constraints) or a target angular resolution for the gesture-training module 106. In some implementations, the angle estimator 518 can include a neural network 832, a convolutional neural network (CNN) 834, or a long short-term memory (LS™) network 836. The neural network 832 can have various depths or quantities of hidden layers (e.g., three hidden layers, five hidden layers, or ten hidden layers) and can also include different quantities of connections (e.g., the neural network 832 can comprise a fully connected neural network or a partially-connected neural network). In some cases, the CNN 834 can be used to increase computational speed of the angle estimator 518. The LS™ network 836 can be used to enable the angle estimator 518 to track the target. Using machine-learning techniques, the angle estimator 518 employs non-linear functions to analyze the shape of the amplitude response 828-1 or 828-2 and generate angular probability data 838, which indicates a likelihood that the user or a portion of the user is within an angular bin. The angle estimator 518 may provide the angular probability data 838 for a few angular bins, such as two angular bins to provide probabilities of a target being to the left or right of the electronic device 102, or for thousands of angular bins (e.g., to provide the angular probability data 838 for a continuous angular measurement).

Based on the angular probability data 838, a tracker module 840 produces angular position data 842, which identifies an angular location of the target. The tracker module 840 may determine the angular location of the target based on the angular bin that has a highest probability in the angular probability data 838 or based on prediction information (e.g., previously-measured angular position information). The tracker module 840 may also keep track of one or more moving targets to enable the radar system 104 to confidently distinguish or identify the targets. Other data can also be used to determine the angular position, including range, Doppler, velocity, or acceleration. In some cases, the tracker module 840 can include an alpha-beta tracker, a Kalman filter, a multiple hypothesis tracker (MHT), and so forth.

A quantizer module 844 obtains the angular position data 842 and quantizes the data to produce quantized angular position data 846. The quantization can be performed based on a target angular resolution for the gesture-training module 106. In some situations, fewer quantization levels can be used such that the quantized angular position data 846 indicates whether the target is to the right or to the left of the electronic device 102 or identifies a 90-degree quadrant the target is located within. This may be sufficient for some radar-based applications, such as user proximity detection. In other situations, a larger number of quantization levels can be used such that the quantized angular position data 846 indicates an angular position of the target within an accuracy of a fraction of a degree, one degree, five degrees, and so forth. This resolution can be used for higher-resolution radar-based applications, such as gesture recognition, or in implementations of the gesture zone, recognition zone, aware mode, engaged mode, or active mode as described herein. In some implementations, the digital beamformer 516, the angle estimator 518, the tracker module 840, and the quantizer module 844 are together implemented in a single machine-learning module.

These and other capabilities and configurations, as well as ways in which entities of FIG. 1-8 act and interact, are set forth below. The described entities may be further divided, combined, used along with other sensors or components, and so on. In this way, different implementations of the electronic device 102, with different configurations of the radar system 104 and non-radar sensors, can be used to implement aspects of facilitating user-proficiency in using radar gestures to interact with an electronic device. The example operating environment 100 of FIG. 1 and the detailed illustrations of FIGS. 2-8 illustrate but some of many possible environments and devices capable of employing the described techniques.

Example Methods

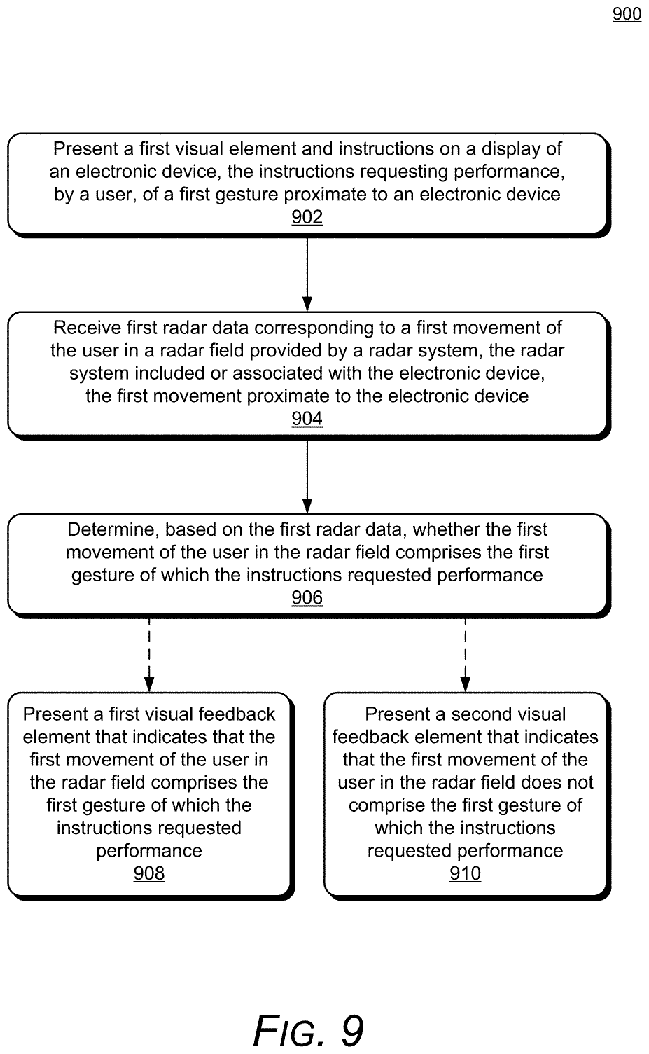

FIGS. 9-22 and 23-33 depict example methods 900 and 2300, which enable facilitating user-proficiency in using radar gestures to interact with an electronic device. The methods 900 and 2300 can be performed with an electronic device that includes, or is associated with, a display, a computer processor, and a radar system that can provide a radar field, such as the electronic device 102 (and the radar system 104). The radar system and radar field can provide radar data, based on reflections of the radar field from objects in the radar field (e.g., the user 112 or a portion of the user 112, such as a hand). For example, the radar data may be generated by, and/or received through, the radar system 104, as described with reference to FIGS. 1-8. The radar data is used to determine interactions of the user with the electronic device, such as a presence of the user in the radar field and gestures made by the user (e.g., radar gestures). Based on the determination of the user's presence, movements, and gestures, the electronic device can enter and exit different modes of functionality and present different elements on the display, including visual elements, visual gaming elements, and visual feedback elements.

The visual elements described with reference to the methods 900 and 2300 can enable the electronic device to provide training and practice to a user in performing radar-gesture interactions with the electronic device. Further, the visual elements can provide feedback to the user to indicate the success and efficiency of the user's radar-gesture interactions with the electronic device. Additional examples of the visual elements are described with reference to FIGS. 10-22 and 24-33.

The method 900 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example operating environment 100 of FIG. 1 or to entities or processes as detailed in FIGS. 2-8, reference to which is made for example only. The techniques are not limited to performance by one entity or multiple entities operating on one device.

At 902, a visual element and instructions are presented on a display of a radar-gesture-enabled electronic device. The visual element and instructions request a user to perform a gesture proximate to the electronic device. For example, the gesture-training module 106 can present the visual element 122 (which can include the visual element 122-1) and instructions on the display 114 of the electronic device 102. The requested gesture can be a radar-based touch-independent radar gesture (as described above), a touch gesture (e.g., on a touch screen), or another kind of gesture, such as a camera-based touch-independent gesture. The visual element 122 can be any of a variety of suitable elements the user 112 can interact with using the requested gesture (e.g., a radar-gesture). In some cases, for example, the visual element 122 can be a set of objects, such as a ball and a dog or a mouse in a maze. In other cases, the visual element 122 can be characters or objects in a game-play environment, such as an animated character with a task to perform (e.g., a Pikachu) or a car on a racetrack.

The instructions included with the visual element 122 can take any of a variety of forms (e.g., textual, non-textual, or implicit instructions). For example, the instructions can be text presented on the display 114, separate from the visual element (e.g., a line of text that reads “swipe from left to right to throw the ball to the dog” may be presented along with the ball and dog illustrated in FIG. 1). The non-textual instructions provided by the visual element 122 can be an animation of the visual element 122, audio instructions (e.g., through a speaker associated with the electronic device 102), or another type of non-textual instruction. For example, the non-textual instructions can be an animation of the dog illustrated in FIG. 1 in which the dog wags its tail and jumps into the air, or an animation in which the ball moves toward the dog and the dog catches the ball. In other cases, the instructions can be implicit in the presentation of the visual element 122 (e.g., a dog and a ball presented together can implicitly instruct the user to try to throw the ball to the dog, without additional instruction).

At 904, radar data corresponding to a movement of the user in a radar field provided by a radar system is received. The radar system may be included or associated with the electronic device, and the movement is proximate to the electronic device. For example, the radar system 104, as described with reference to FIGS. 1-8, may provide the radar data.

At 906, it is determined, based on the radar data, whether the movement of the user in the radar field comprises the gesture of which the instructions requested performance. For example, the gesture-training module 106 can determine whether the movement of the user in the radar field 110 is a radar gesture (e.g., a radar-based touch-independent gesture, as described above).

In some implementations, the gesture-training module 106 can determine whether the movement of the user in the radar field 110 is a radar gesture by using the radar data to detect values of a set of parameters that are associated with the movement of the user in the radar field. For example, the set of parameters can include values representing one or more of a shape of the movement of the user in the radar field 110, a path of the movement of the user in the radar field 110, a length of the movement of the user in the radar field 110, a velocity of the movement of the user in the radar field 110, or a distance of the user in the radar field 110 from the electronic device 102. The gesture-training module 106 then compares the values of the set of parameters to benchmark values for the set of parameters. For example, the gesture-training module 106 can compare the values for the set of parameters to benchmark values that are stored by the gesture library 120, as described above. The benchmark values may be values of the parameters that correspond to the gesture of which the instructions requested performance.

When the values of the set of parameters associated with the movement of the user meet the criteria defined by the benchmark parameters, the gesture-training module 106 determines that the movement of the user in the radar field is a radar gesture. Similarly, when the values of the set of parameters associated with the movement of the user do not meet the criteria defined by the benchmark parameters, the gesture-training module 106 determines that the movement of the user in the radar field is not a radar gesture. In some cases, the gesture-training module 106 may use a range of benchmark values (e.g., stored by the gesture library 120) that allow some variation in the values of the set of parameters that cause the gesture-training module 106 to determine that the movement of the user is a radar gesture.

Further, in some implementations, the electronic device 102 may include machine-learning techniques that can generate adaptive or adjusted benchmark values associated with the gesture of which the instructions requested performance. The adjusted benchmark values are generated based on radar data that represents multiple attempts by the user to perform the gesture of which the instructions requested performance. For example, the user may repeatedly attempt to make the requested gesture without success (e.g., the values of the parameters associated with the user's attempted gestures do not fall within the values of the benchmark parameters). In this case, the machine-learning techniques can generate a set of adjusted benchmark values that include at least some of the values of the parameters associated with the user's unsuccessful gestures.

The gesture-training module 106 may then receive radar data corresponding to the user's movement (e.g., after the failed gesture attempts) in the radar field and detect values of another set of parameters that are associated with the movement of the user. As described above, the gesture-training module 106 can then compare the detected values of the other set of parameters to the adjusted benchmark values and determine, based on the comparison, whether the movement of the user in the radar field is the gesture of which the instructions requested performance. Because the adjusted parameters are based on a machine-learned set of parameters, the user's gesture can be determined to be the requested radar gesture, even when the user's gestures would not be the requested gesture based on a comparison to unadjusted benchmark values. In this way, the adjusted benchmark values allow the electronic device and the gesture-training module 106 to learn to accept more variation in how users make radar gestures (e.g., when the variation is consistent). These techniques can also allow a specific user's gestures to be recognized. For example, if a user is physically unable to make the gesture as defined by the benchmark parameters.

In some implementations, the visual element 122 and the associated instructions can also be used to increase the accuracy of the adjusted benchmark values and decrease the time it takes to generate the adjusted benchmark values. For example, the machine-learning technology can direct the gesture-training module 106 to present instructions, such as text or audio, that ask the user whether the user's movement is intended to be the requested gesture. The user can reply (e.g., using a radar gesture, touch input, or voice input), and the gesture-training module 106 can then ask the user to repeat the requested gesture until the machine-learning technology has enough data to generate the adjusted benchmark values.

Optionally at 908, in response to determining that the movement of the user in the radar field is the gesture of which the instructions requested performance, a visual feedback element is presented on the display. The visual feedback element indicates that the movement of the user in the radar field is the radar gesture of which the instructions requested performance. For example, in response to the determination that the user's movement is the requested radar gesture, the gesture-training module 106 can present the visual feedback element 126 (which can include one or both of the visual feedback elements 126-1 and 126-2) on the display 114.

Consider an example illustrated in FIG. 10, which illustrates, generally at 1000, additional examples of the visual element 122 and the visual feedback element 126. A detail view 1000-1 illustrates an example electronic device 102 (in this case, the smartphone 102-1) that is presenting an example visual element 1002, which includes a ball component 1002-1 and a dog component 1002-2. In the detail view 1000-1, the ball component 1002-1 is presented at the left edge of the display 114, and the dog component 1002-2 is presented at the right edge of the display 114. The detail view 1000-1 also illustrates a location 1004 where optional textual instructions associated with the example visual element 1002 may be displayed (e.g., a textual instruction to perform the swipe-left-to-right radar gesture).

Another detail view 1000-2 illustrates an example visual feedback element 1006, which includes a ball component 1006-1 and a dog component 1006-2. In the example of the detail view 1000-2, assume that the user 112 successfully performed the requested gesture (e.g., the gesture-training module 106 determined, based on radar data, that the user's movement in the radar field 110 is the requested radar gesture). The gesture can be any of a variety of gestures, including a swipe gesture (e.g., left-to-right or right-to-left) or a direction-independent gesture (e.g., an omni-gesture). In response to the successfully performed radar gesture, the gesture-training module 106 presents the visual feedback element 1006 by animating the visual element 1002. In an example animation, the ball component 1006-1 moves from the left edge of the display 114 toward the dog component 1006-2, as shown by an arrow 1008. As the ball component 1006-1 approaches, the dog component 1006-2 moves to pick up the ball component 1006-1. The detail view 1000-2 also illustrates a location 1010 where additional optional textual instructions associated with the example visual feedback element 1006 may be displayed (e.g., instructions to perform the requested gesture again or a message acknowledging successful performance of the requested gesture).

Returning to FIG. 9, optionally at 910, in response to determining that the movement of the user in the radar field is not the gesture of which the instructions requested performance, another visual feedback is presented on the display. The other visual feedback element indicates that the first movement of the user in the radar field is not or does not include the gesture of which the instructions requested performance. For example, in response to the determination that the user's movement is not the requested gesture, the gesture-training module 106 can present another visual feedback element on the display 114.

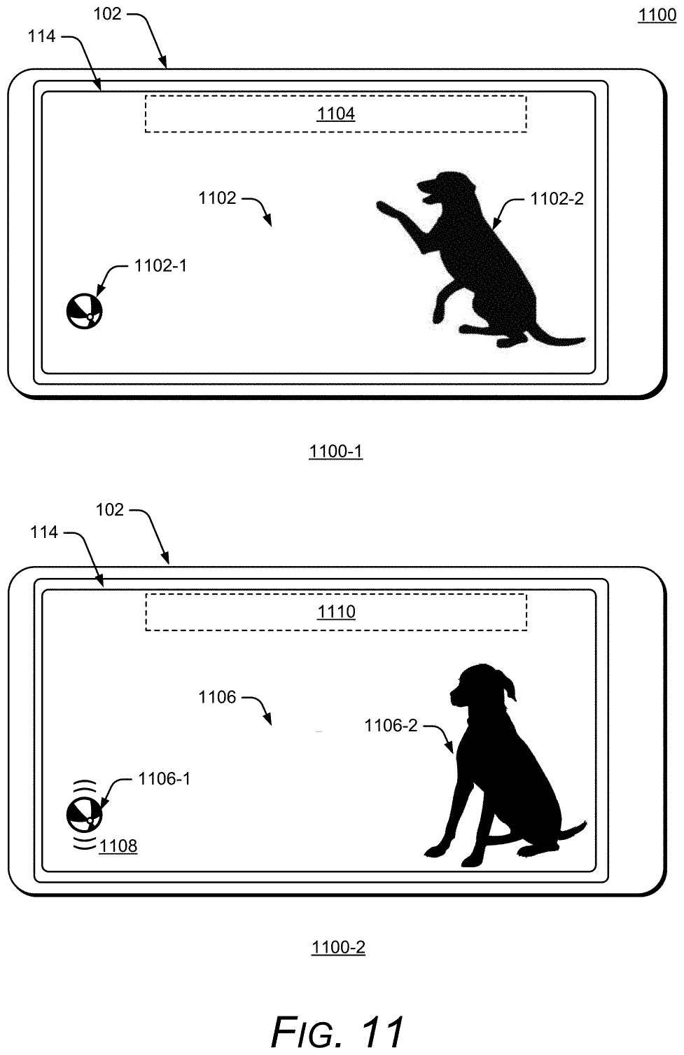

Consider an example illustrated in FIG. 11, which illustrates, generally at 1100, additional examples of the visual element 122 and the visual feedback element 126. A detail view 1100-1 illustrates an example electronic device 102 (in this case, the smartphone 102-1) that is presenting an example visual element 1102, which includes a ball component 1102-1 and a dog component 1102-2. In the detail view 1100-1, the ball component 1102-1 is presented at the left edge of the display 114, and the dog component 1102-2 is presented at the right edge of the display 114. The detail view 1100-1 also illustrates a location 1104 where optional textual instructions associated with the example visual element 1102 may be displayed (e.g., a textual instruction to perform the swipe-left-to-right radar gesture).

Another detail view 1100-2 illustrates an example visual feedback element 1106, which includes a ball component 1106-1 and a dog component 1106-2. In the example of the detail view 1100-2, assume that the user 112 failed to perform the requested gesture (e.g., the gesture-training module 106 determined, based on radar data, that the user's movement in the radar field 110 is not the requested radar gesture). The gesture can be any of a variety of gestures, including a swipe gesture (e.g., left-to-right or right-to-left) or a direction-independent gesture (e.g., an omni-gesture). In response to the failed radar gesture, the gesture-training module 106 presents the visual feedback element 1106 by animating the visual element 1102. In an example animation, the ball component 1106-1 briefly bounces up and down, as shown by a motion indicator 1108. As the ball component 1106-1 bounces, the dog component 1106-2 sits down. The detail view 1100-2 also illustrates a location 1110 where additional optional textual instructions associated with the example visual feedback element 1106 may be displayed (e.g., instructions to perform the requested gesture again or a message acknowledging successful performance of the requested gesture).

After the visual feedback element 1106 is presented for a time duration, the gesture-training module 106 may stop presenting the visual feedback element 1106 and present the visual element 1102. The time duration may be any suitable time duration that allows the user 112 to view the visual feedback element 1106 (e.g., approximately two, four, or six seconds). The time duration may be selectable and/or adjustable by the user 112. In some cases, the user may attempt another gesture, in which case the gesture-training module 106 may stop presenting the visual feedback element 1106 and present the visual element 1102, even if the time duration has not expired.

After determining that the movement of the user in the radar field is not the requested gesture and while the visual element 1102 is being presented (e.g., after the time duration has ended or when the gesture-training module 106 determines that the user is performing a movement in the radar field), additional radar data may be received. The additional radar data can correspond to another movement of the user 112 in the radar field 110 (e.g., after an unsuccessful attempt to perform the requested gesture, the user 112 may make another attempt). Based on the additional radar data, the gesture-training module 106 can determine that the other movement of the user 112 is the requested gesture (e.g., using the benchmark values, as described above). In response to determining that the other movement of the user 112 is the requested gesture, the gesture-training module 106 can present the visual feedback element 1006, to indicate that the other movement of the user 112 is the requested gesture.

In some implementations, the gesture-training module 106 can present other visual feedback elements instead of, or in addition to, the visual feedback elements 1006 and 1106. For example, the gesture-training module 106 may provide a set of system-level visual feedback elements that are similar or the same for the radar-gesture applications that operate on the electronic device 102 (but different from the visual feedback elements 1006 and 1106).

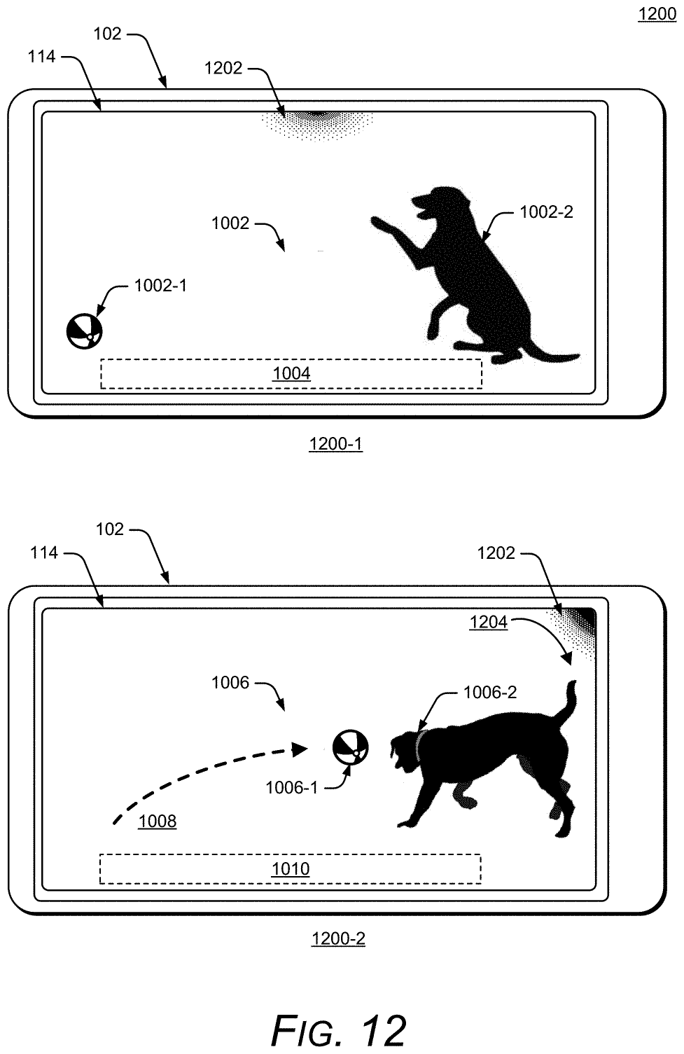

Consider FIG. 12, which illustrates, generally at 1200, examples of a visual feedback element 1202. A detail view 1200-1 illustrates an example electronic device 102 (in this case, the smartphone 102-1) that is presenting the example visual feedback element 1202, which is shown as an illuminated area (e.g., a glowing area). As with the visual elements 1002 and 1102, and the visual feedback elements 1006 and 1106, the visual feedback element 1202 can be presented at another location on the display 114, at a different illumination level (e.g., more-illuminated or less-illuminated), or as another shape or type of element. The detail view 1200-1 also illustrates the location 1004 where the optional textual instructions associated with the example visual element 1002 may be displayed. As shown, the location 1004 is being presented at a different location because the visual feedback element 1202 is being presented at the top of the display 114.

Another detail view 1200-2 illustrates how the example visual feedback element 1202 changes in response to a successful radar gesture. In the example of the detail view 1200-2, assume that the requested gesture is a left-to-right swipe and that the user 112 successfully performed the requested gesture (e.g., the gesture-training module 106 determined, based on radar data, that the user's movement in the radar field 110 is the requested radar gesture). In response to the successfully performed radar gesture, the gesture-training module 106 animates the visual feedback element 1202 by moving it from left to right, around a corner of the display 114, as shown by an arrow 1204. The motion of the visual feedback element 1202 lets the user 112 know that the requested gesture was successfully performed. As shown in FIG. 12, the visual feedback element 1202 is presented with the example visual element 1002 and the example visual feedback element 1006 (and the location 1010). In other cases, the visual feedback element 1202 may be presented without either or both of the visual element 1002 and the visual feedback element 1006. In some cases, the visual feedback element 1202 may be presented with another visual element (not shown).

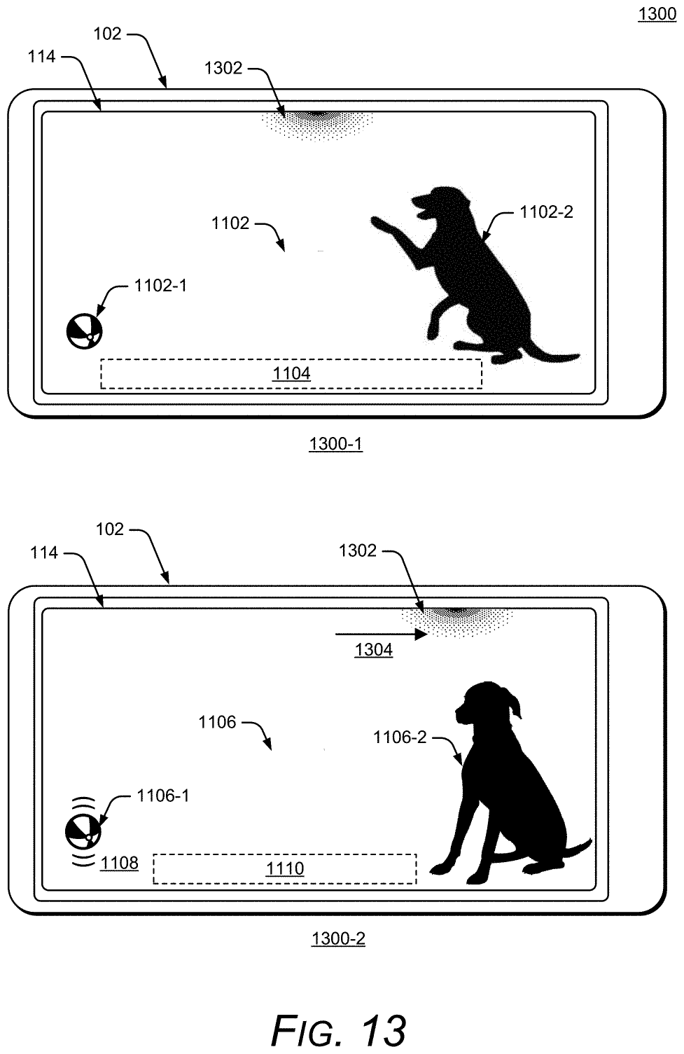

FIG. 13 illustrates, generally at 1300, examples of another visual feedback element 1302 that can be presented when the movement of the user 112 is not or does not include the requested gesture. A detail view 1300-1 illustrates an example electronic device 102 (in this case, the smartphone 102-1) that is presenting the example visual feedback element 1302, which is shown as an illuminated area (e.g., a glowing area). As with the visual elements 1002 and 1102, and the visual feedback elements 1006, 1106, and 1202, the visual feedback element 1302 could be presented at another location on the display 114, at a different illumination level (e.g., more-illuminated or less-illuminated), or as another shape or type of element. The detail view 1300-1 also illustrates the location 1104 where the optional textual instructions associated with the example visual element 1102 may be displayed. As shown, the location 1104 is being presented at a different location because the visual feedback element 1302 is being presented at the top of the display 114.

Another detail view 1300-2 illustrates how the example visual feedback element 1302 changes in response to a failed attempt to perform the requested radar gesture. In the example of the detail view 1300-2, assume that the requested gesture is the left-to-right swipe and that the user 112 failed to perform the requested gesture (e.g., the gesture-training module 106 determined, based on radar data, that the user's movement in the radar field 110 is not the requested radar gesture). In response to the failed gesture, the gesture-training module 106 animates the visual feedback element 1302 by moving it from left to right, as shown by an arrow 1304. In this case, the visual feedback element 1302 does not go around the corner. Instead, the visual feedback element 1302 stops before reaching the corner and returns to the initial position as shown in the detail view 1300-1 (return not shown). The motion of the visual feedback element 1302 lets the user 112 know that the requested gesture was not successfully performed. As shown in FIG. 13, the visual feedback element 1302 is presented with the example visual element 1102, the location 1110, and the example visual feedback element 1106 (including animation, such as the motion 1108 of the ball component 1106-1). In other cases, the visual feedback element 1302 may be presented without either or both of the visual element 1102 and the visual feedback element 1106. In some cases, the visual feedback element 1302 may be presented with another visual element (not shown).

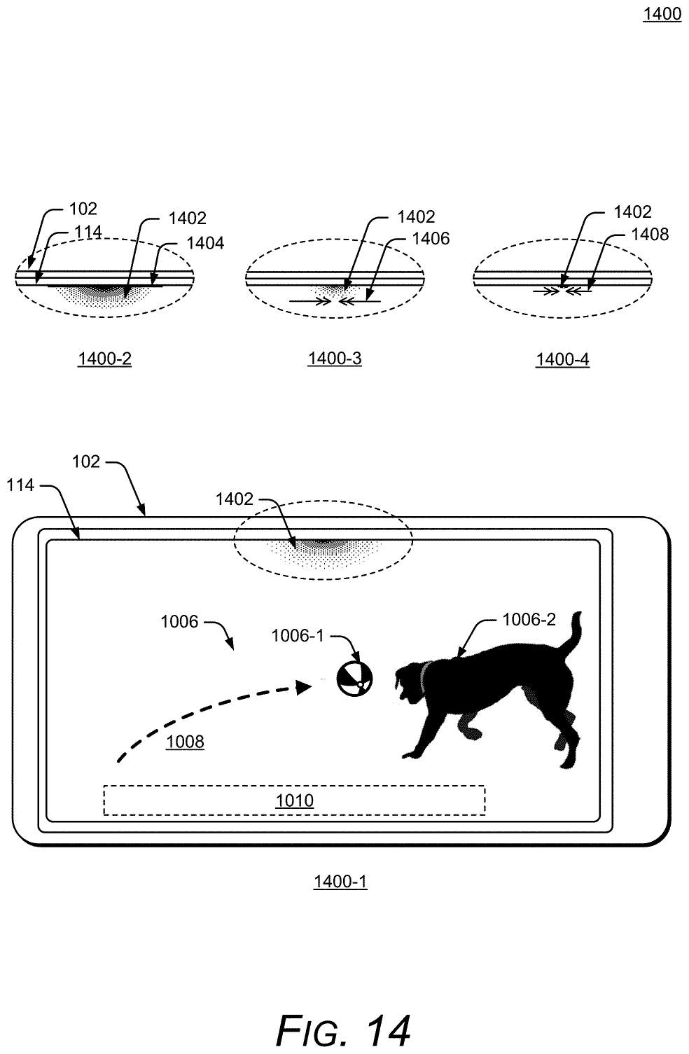

In other implementations, the visual feedback elements 1202 or 1302 can animate in other ways. For example, consider FIG. 14, which illustrates additional examples of visual feedback elements. A detail view 1400-1 illustrates an example electronic device 102 (in this case, the smartphone 102-1) that is presenting an example visual feedback element 1402, which is shown as an illuminated area (e.g., a glowing area). While shown at the top edge of the display 114, the visual feedback element 1402 could be presented at another location on the display 114, at a different illumination level (e.g., more-illuminated or less-illuminated), or as another shape or type of element. The detail view 1400-1 also illustrates the location 1010 where the optional textual instructions associated with the example visual feedback element 1006 may be displayed. As shown, the location 1010 is being presented at a different location because the visual feedback element 1402 is being presented at the top of the display 114.

In the example of the detail view 1400-1, assume that the requested gesture is a direction-independent gesture (e.g., an omni-gesture) and that the user 112 successfully performed the requested gesture (e.g., the gesture-training module 106 determined, based on radar data, that the user's movement in the radar field 110 is the requested radar gesture). In response to the successfully performed radar gesture, the gesture-training module 106 animates the visual feedback element 1402 by increasing the size and brightness (e.g., luminosity) of the visual feedback element 1402, and adding a bright line 1404 proximate to the edge of the display 114, as shown in a detail view 1400-2. The sequence of animation continues in another detail view 1400-3, in which the visual feedback element 1402 begins to decrease in size, as shown by a double-ended arrow 1406. Another detail view 1400-4 illustrates the continuing animation, in which the visual feedback element 1402 further decreases in size, shrinking toward the center of the upper edge of the display 114, as shown by another double-ended arrow 1408. The animation continues until the visual feedback element 1402 disappears and then returns to the state as shown in the detail view 1400-1 (not illustrated). The motion of the visual feedback element 1402 lets the user 112 know that the requested gesture was successfully performed.

As shown in FIG. 14, the visual feedback element 1402 is presented with the visual feedback element 1006 (including animation, such as the motion 1008 of the ball component 1006-1). In other cases, the visual feedback element 1402 may be presented without the visual feedback element 1006, with other content (with or without the visual feedback element 1006), with a visual element (e.g., the visual element 1002), or in another configuration (not illustrated).

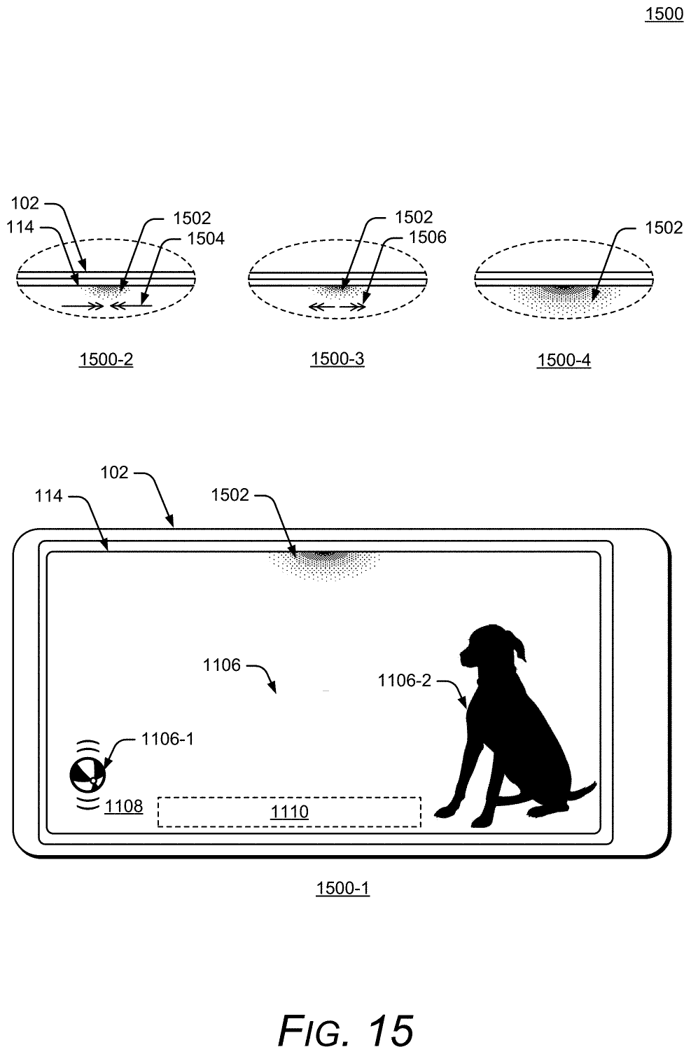

Similarly, consider FIG. 15, which illustrates additional examples of visual feedback elements that can be presented when the movement of the user 112 is not or does not include the requested gesture. A detail view 1500-1 illustrates an example electronic device 102 (in this case, the smartphone 102-1) that is presenting an example visual feedback element 1502, which is shown as an illuminated area (e.g., a glowing area). While shown at the top edge of the display 114, the visual feedback element 1502 can be presented at another location on the display 114, at a different illumination level (e.g., more-illuminated or less-illuminated), or as another shape or type of element. The detail view 1500-1 also illustrates the location 1110 where the optional textual instructions associated with the example visual feedback element 1106 may be displayed. As shown, the location 1110 is being presented at a different location because the visual feedback element 1502 is being presented at the top of the display 114.

In the example of the detail view 1500-1, assume that the requested gesture is a direction-independent gesture (e.g., an omni-gesture) and that the user 112 failed to perform the requested gesture (e.g., the gesture-training module 106 determined, based on radar data, that the user's movement in the radar field 110 is not the requested radar gesture). In response to the unsuccessfully performed radar gesture, the gesture-training module 106 animates the visual feedback element 1502 by decreasing the size and brightness (e.g., luminosity) of the visual feedback element 1502, as shown in a detail view 1500-2. The sequence of animation continues in another detail view 1500-3, in which the visual feedback element 1502 stops shrinking and begins to brighten and expand, as shown by another double-ended arrow 1506. Another detail view 1500-4 illustrates the continuing animation, in which the visual feedback element 1502 returns to the state as shown in the detail view 1500-1. The motion of the visual feedback element 1502 lets the user 112 know that the requested gesture was not successfully performed.

As shown in FIG. 15, the visual feedback element 1502 is shown with the visual feedback element 1106 (including animation, such as the motion 1108 of the ball component 1106-1). In other cases, the visual feedback element 1502 may be presented without the visual feedback element 1106, with other content (with or without the visual feedback element 1106), with a visual element (e.g., the visual element 1102), or in another configuration (not illustrated).

In some implementations, the electronic device 102 and the radar system 104 may include a gesture-paused mode. In the gesture-paused mode, a gesture-pause trigger event is detected during a period in which the radar system is providing the radar field and a radar-gesture application is executing on the electronic device. The gesture-paused mode is entered in response to detecting the gesture-pause trigger event. In the gesture-paused mode, when the radar-gesture application is executing on the electronic device, the electronic device provides another visual feedback element that indicates the electronic device is in the gesture-paused mode.

% N The electronic device 102 can detect the gesture-pause trigger event through input from the radar system 104 and/or input from other sensors (e.g., a camera, or the non-radar sensor 108). The gesture-pause trigger event is a condition, a set of conditions, or a state in which radar gestures are paused because the radar-gesture applications cannot perform actions associated with the radar gesture. Generally, the gesture-pause trigger event is a condition that can make it difficult for the electronic device 102 or the radar system 104 to accurately and efficiently determine whether a user's movement is a radar gesture. For example, the gesture-pause trigger event can be an oscillating motion of the electronic device 102 that exceeds a threshold frequency, a motion of the electronic device at a velocity above a threshold velocity, or an oscillating motion of an object in the radar field, such as the user 112 (or a portion of the user 112), that exceeds a threshold frequency.

In response to detecting the gesture-pause trigger event, the electronic device 102 enters the gesture-paused mode. If the radar-gesture application (e.g., an application capable of receiving a control input corresponding to the radar gesture) is executing on the electronic device 102 while the electronic device 102 is in the gesture-paused mode, gesture-training module 106 provides a visual feedback element on the display 114 of the electronic device 102. In this case, the user 112 may or may not have attempted to make a radar gesture. The gesture-training module 106 provides the visual feedback element based on detection of the gesture-pause trigger event and does not require that a radar gesture was attempted. Rather, the visual feedback element alerts the user that radar gestures are not currently available to control the radar-gesture applications on the electronic device 102.

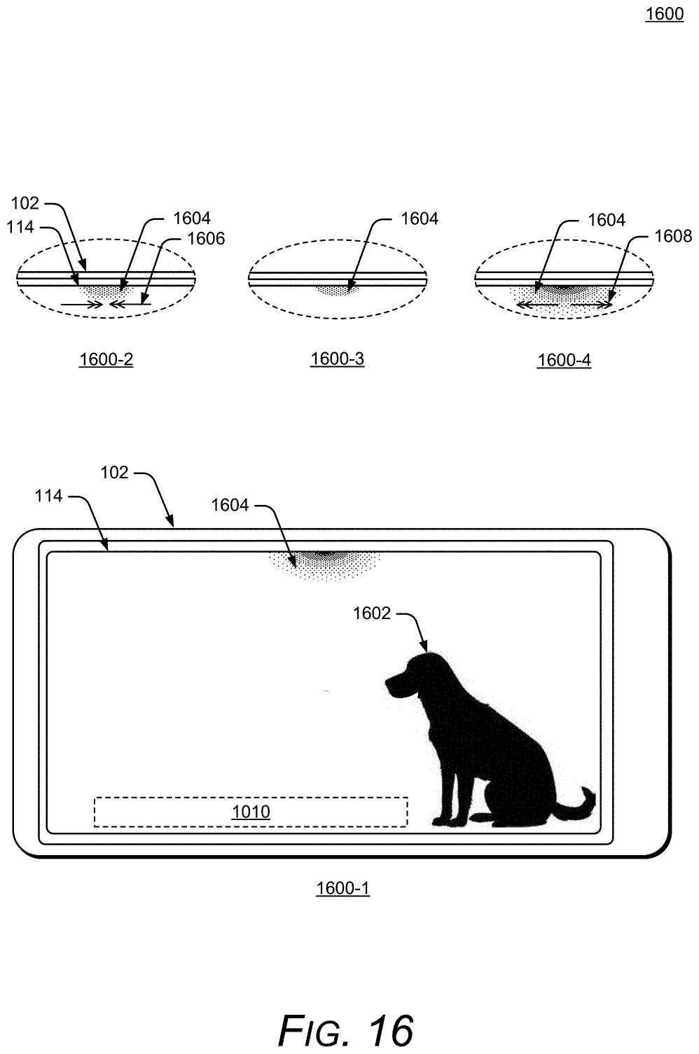

Consider an example illustrated in FIG. 16, which illustrates, generally at 1600, examples of a visual feedback element that indicates that the electronic device 102 and/or the radar system 104 are in the gesture-paused mode. A detail view 1600-1 illustrates an example electronic device 102 (in this case, the smartphone 102-1) that is presenting an example visual feedback element 1602, which is shown as a dog that is sitting down. In this case, the visual feedback element indicates the gesture-paused mode by eliminating the ball component (e.g., 1002-1 or 1102-1) and animating the dog component (e.g., 1002-2 or 1102-2) of the visual element that is presented to indicate that the gesture-training module 106 is unable to accept a gesture (e.g., the visual element 1002 or 1102). The detail view 1600-1 also illustrates the location 1010 where additional optional textual instructions associated with the example visual feedback element 1602 may be displayed (e.g., instructions to wait to perform the requested gesture and/or a message explaining that the electronic device 102 is in the gesture-paused mode).

In some implementations, the gesture-training module 106 can present other visual feedback elements instead of, or in addition to, the visual feedback element 1602. For example, the gesture-training module 106 may provide another visual feedback element 1604, which may be part of the set of system-level visual feedback elements described with reference to FIGS. 12-15. In FIG. 16, the other visual feedback element 1604 is an illuminated area (e.g., a glowing area) at the top edge of the display 114. In other cases, the visual feedback element 1604 may be presented at another location on the display 114, at a different illumination level (e.g., more-illuminated or less-illuminated), or as another shape or type of element.

In the example of the detail view 1600-1, the visual feedback element 1604 is being presented in a form that indicates that the electronic device 102 can receive and be controlled by radar gestures (e.g., similar to the visual feedback elements 1202, 1302, 1402, and 1502). When the electronic device 102 enters the gesture-pause mode, the gesture-training module 106 animates the visual feedback element 1604 to alert the user. The gesture-training module 106 begins the animation by decreasing the size and brightness (e.g., luminosity) of the visual feedback element 1604, as shown by a double-ended arrow 1606 in a detail view 1600-2. The sequence of animation continues in another detail view 1600-3, in which the visual feedback element 1604 has stopped shrinking and is displayed near the center of the top edge of the display 114. The smaller, dimmer, visual feedback element 1604 indicates that the gesture-paused mode is engaged. A detail view 1600-4 illustrates the end of the animation (e.g., the end of the gesture-pause mode), showing the visual feedback element 1604 returning to the state shown in the detail view 1600-1 by increasing in size and brightness, as shown by another double-ended arrow 1608. As shown in FIG. 16, the visual feedback element 1604 is presented with the visual feedback element 1602. In other cases, the visual feedback element 1604 may be presented without the visual feedback element 1602, with other content (with or without the visual feedback element 1602), with a visual element (e.g., the visual elements 1002 and/or 1102), or in another configuration (not illustrated).

FIGS. 10-16 also illustrate locations (e.g., the locations 1004, 1010, 1104, and 1110) where optional textual instructions associated with the example visual elements 1002 and 1102 and the example visual feedback elements 1006 and 1106 may be displayed. These text locations may include any suitable instruction, explanation, or message related to the requested gesture, the user's performance of the requested gesture, and so forth. For example, the textual instructions can include instructions to perform the requested gesture, instructions to perform the requested gesture again, a message explaining or related to the requested gesture, or a message acknowledging successful performance of the requested gesture.

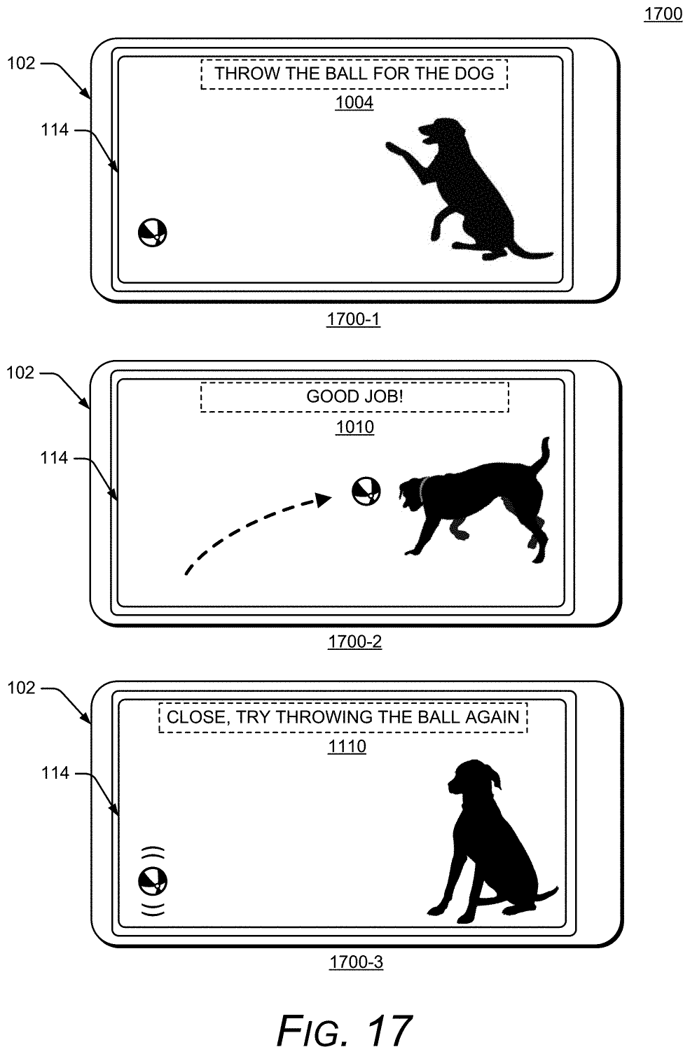

Consider FIG. 17, which illustrates examples of textual instructions that can be presented. In a detail view 1700-1, the location 1004 is displaying a textual message (“Throw the ball for the dog.”) that indicates the requested gesture (e.g., a swipe gesture from left to right to move the ball toward the dog). Other variations of the textual instruction include “Swipe right to throw the ball to the dog.” or “Use a gesture to send the ball to the dog.” In another detail view 1700-2, the location 1010 is displaying a textual message (“Good Job!”) that indicates that the user 112 successfully performed the requested gesture. Other variations of the textual instruction include “Success!” or “That was very good.” Another detail view 1700-3 illustrates an example instruction that indicates that the user 112 failed to successfully perform the requested gesture (“Close, try throwing the ball again”). Other variations of the textual instruction include “Almost, try again.” or “One more try. You got this.”

In some implementations (not illustrated), the instructions can also include messages or feedback related to the requested gesture. For example, the instruction can be a message that informs the user 112 how the visual feedback element 1202 works (e.g., “Make a gesture to throw the ball, and the dog will fetch it”). In another example, the gesture-training module 106 is displaying the other visual feedback elements described with reference to FIGS. 12-16 (e.g., the set of system-level visual feedback elements). Consider a case in which the gesture-training module 106 is displaying the visual elements illustrated in FIG. 12 (e.g., in the detail views 1200-1 and 1200-2). In this case, the gesture-training module 106 may present a textual instruction at the location 1004, such as “Watch the glow at the top of the screen move when you try to throw the ball.” Similarly, the gesture-training module 106 may present a textual instruction at the location 1010, such as “See how the glow went around the corner to show you made the gesture.”

After the requested gesture is successfully performed, either on a first or a subsequent attempt, the gesture-training module 106 may continue to offer training to the user or stop offering training. In cases in which the training continues, the gesture-training module 106 may present the same visual element (keep practicing the same gesture) or a different visual element and instructions (e.g., to practice a different gesture or to practice the same gesture in a different environment). Thus, the user's unsuccessful attempt to perform the requested gesture causes the electronic device 102 to repeat the visual element and the request. Alternately or additionally, the user's successful performance of the requested gesture can cause the electronic device to provide a different visual element so that the user can receive training in other gestures after successfully performing the previous requested gesture. In some implementations, the gesture-training module 106 may present the first visual feedback element and instructions a number of times (e.g., one, three, five, or seven times) before presenting the next visual element. The number of times each visual element is presented may be user-selectable. Further, the gesture-training module 106 may use the textual instructions to ask the user if the training should stop or continue (e.g., “Do you want to throw the ball again?” or “Do you want to try a different gesture?”).

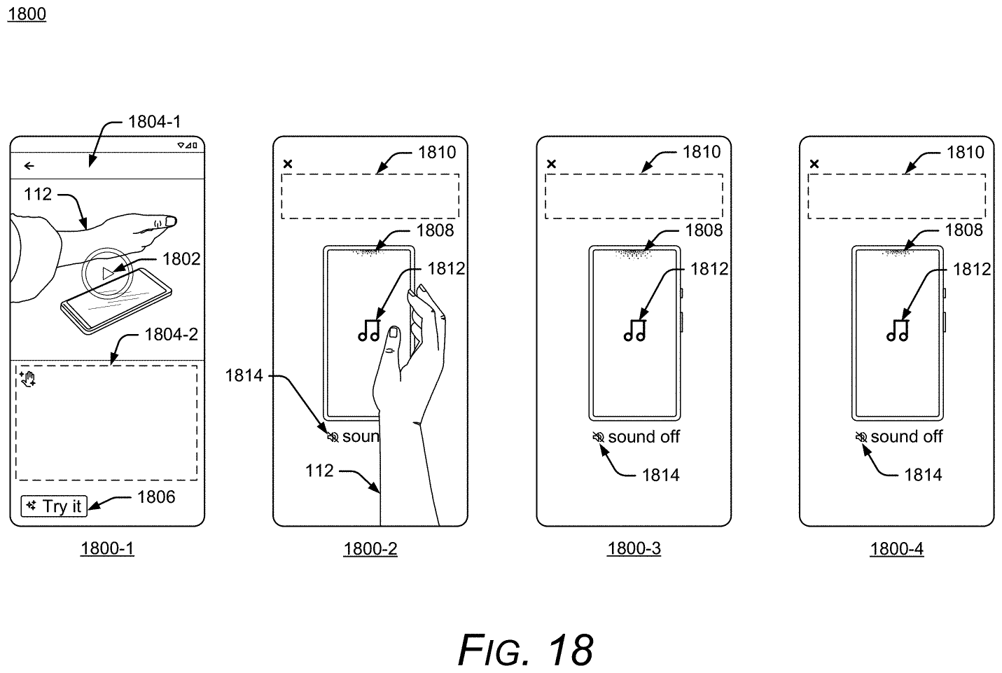

The method 900 may be implemented in other ways, as well. For example, consider FIGS. 18-22, which illustrate another example of a tutorial-style practice and training environment (e.g., a user “tips” environment) along with additional example visual elements 122 and visual feedback elements 126. For example, FIG. 18 depicts, at 1800, an entry sequence for the other example environment (e.g., the tips environment). For example, a detail view 1800-1 illustrates an example display 114 that is presenting (e.g., through the gesture-training module 106) a tips detail page, which includes a video the user 112 may view to learn about using radar gestures. The user may access the video using a control 1802. The tips detail page, as shown in the detail view 1800-1, may also include one or more text areas 1804, which can display text that describes how a radar gesture can be used to skip a song, snooze an alarm, or mute a ringing phone.

For example, in a text area 1804-1, the gesture-training module 106 can present a title, such as “Tips Details” or “Become an Expert.” Similarly, using another text area 1804-2 (shown as a dashed-line rectangle), the gesture-training module 106 can present a message, such as “Swipe left or right above the phone to skip songs” or “Swipe in any direction above the phone to snooze alarms or mute the phone ringer” (or both messages). In some cases, the message can have a heading, such as “Use Quick Gestures” or “How to Use Radar Gestures.”

The gesture-training module 106 can also present a control 1806 that can be used to enter the tips tutorial (e.g., a “Try it” icon). For example, if the user 112 uses the control 1806 to enter the tips tutorial, the gesture-training module 106 can present a training screen, illustrated in another detail view 1800-2, which explains how to perform the radar gesture for skipping songs. The training screen in the detail view 1800-2 illustrates a smartphone and an animation of a user's hand 112 above the smartphone. The smartphone also displays a visual feedback element 1808 (e.g., the visual feedback element 1202, 1302, 1402, 1502, or 1604). The training screen and animation may be presented in response to the user activating the control 1806.

The training screen can also include a text area 1810 (shown as a dashed-line rectangle), which can display text that instructs the user to perform a radar gesture to skip songs (e.g., “Swipe left or right above the phone”). The text area 1810 can also be used to display a title for the tips tutorial (e.g., “Skip songs” or “Music Player”). In some implementations, audio instructions may also be available (e.g., the user may select text, audio, or both and select a default option, such as only text). In some cases, an icon 1812 may be presented on the smartphone to indicate that an application, such as a music player, is running (e.g., a musical note) or radar gesture-enabled. When the application is a music player, the tips environment may operate in a default mode (user-selectable) in which the sound is off, as shown by a sound control 1814. The sound control 1814 lets the user know that the sound is off and that the user can toggle the sound on and off with the sound control 1814.

In another detail view 1800-3, the animation sequence continues when the user reaches for the electronic device 102. In the continued sequence, the animation of the user's hand 112 disappears, and the smartphone displayed on the training screen continues to show the visual feedback element 1808, which expands when the user 112 reaches for the electronic device 102. The training screen can still present the text area 1810 with text that instructs the user to swipe left or right above the smartphone to skip songs. Another detail view 1800-4 illustrates the results of a partial gesture (e.g., a radar gesture that is unsuccessfully performed, as described above). In the detail view 1800-4, the animation continues by returning the visual feedback element 1808 to its original size and changing the instructional text in the text area 1810 to include more detail to help the user perform the radar gesture to skip songs (e.g., changing from “Swipe left or right above the phone” to “Try a sweeping motion past both edges of the phone”). In some cases, audio or tactile (haptic) feedback (e.g., vibration) may be included with the new textual instructions (e.g., a sound or haptic that indicates a rejected input).

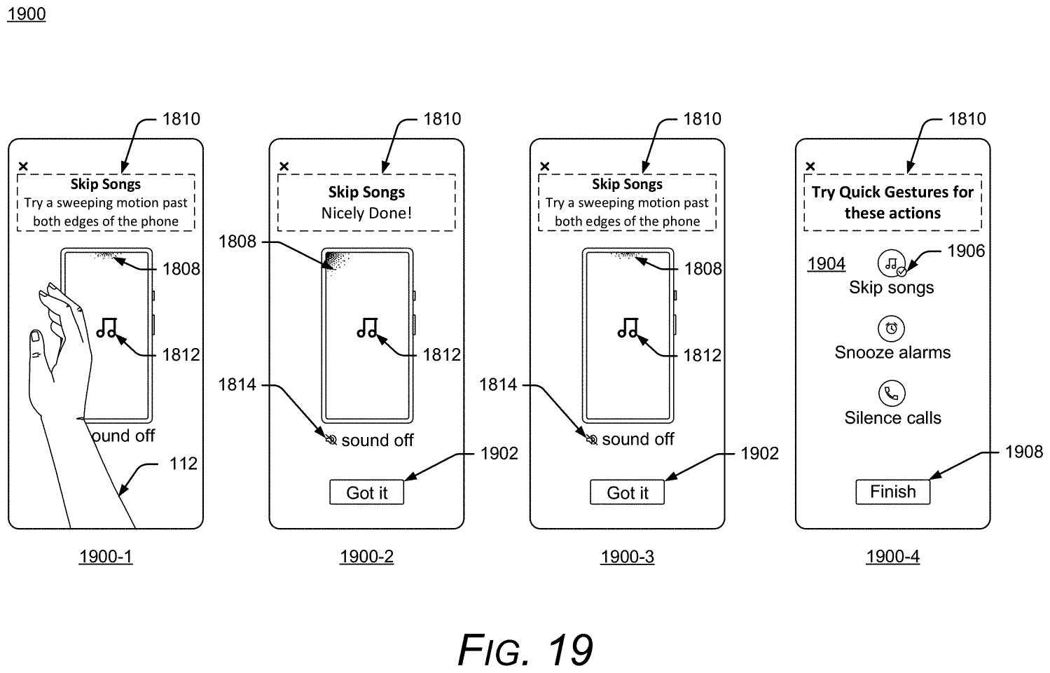

FIG. 19 illustrates, at 1900, additional training screens that may be presented in the tips tutorial. For example, a detail view 1900-1 illustrates a training screen that appears after the user performs a selectable number of partial gestures without a successful swipe (e.g., one, two, three, or four partial gestures. The training screen of the detail view 1900-1 illustrates a smartphone and a different animation of the user's hand above the smartphone, and the instructional text presented in the text area 1810 tells the user to “Try a sweeping motion past both edges of the phone” to skip songs.

Another detail view 1900-2 illustrates the results of a swipe gesture (e.g., a swipe radar gesture that is successfully performed, as described above). In the detail view 1900-2, the animation continues by causing the visual feedback element 1808 to move toward and around a corner of the example smartphone (e.g., as illustrated in FIG. 12). In the detail view 1900-2, the instructional text presented in the text area 1810 changes to “Nicely done!” and the song skips to the next in the playlist. As noted with reference to FIG. 18, the tips environment may operate in a default mode (user-selectable) in which the sound is off, as shown by the sound control 1814. Audio or tactile (haptic) feedback may also be provided, if available (e.g., a sound or haptic that indicates a confirmed input). In some cases, the music icon 1812 also moves or translates across the screen in response to the successful swipe (not shown). Additionally, the training screen presents a return control 1902 that allows the user 112 to exit the skip songs tutorial (e.g., a “Got it” icon).

Another detail view 1900-3 illustrates a training screen that is presented if the user 112 does not activate the return control 1902. In the detail view 1900-3, the animation is presented with the smartphone and the visual feedback element 1808 in the same state as in the detail view 1800-2 and 1800-4 (while also presenting the return control 1902). Another detail view 1900-4 illustrates the training screen after the user 112 activates the return control 1902. In the detail view 1900-4, the animation ends, and a summary page is presented. The summary page includes text in the text area 1810 that informs the user 112 about other training options (“Try Quick Gestures for these actions”). The gesture-training module 106 also presents tutorial controls 1904 that allow the user 112 to re-enter the tips environment for skipping songs or enter other tips tutorials for snoozing alarms and silencing calls. The tutorial controls 1904 include text and icons (e.g., a music note for “Skip songs,” an alarm clock for “Snooze alarms,” and a classic telephone handset for “Silence calls”). The tutorial controls 1904 are presented with an indicator 1906 (e.g., a check-mark icon), which lets the user 112 know which tutorials have been completed. In some cases, the tutorial controls 1904 are ordered based on whether the tutorial has been completed (e.g., completed tutorials are at the top of the list and uncompleted tutorials are at the bottom of the list). The summary page also can also include an exit control 1908, which allows the user 112 to exit the tips tutorial environment (e.g., a “Finish” icon).

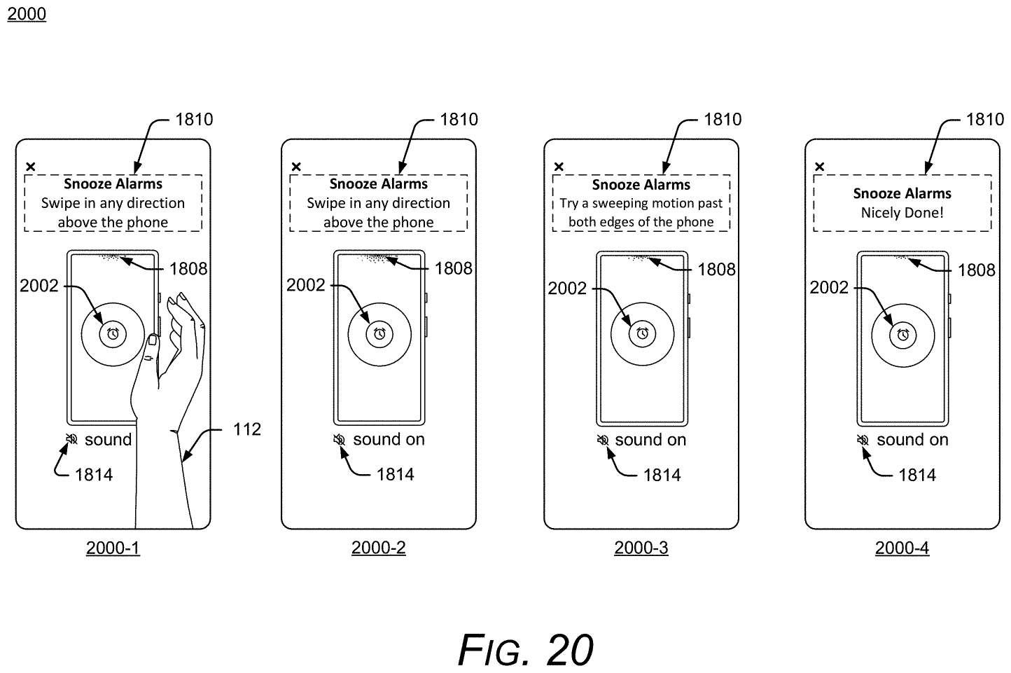

FIG. 20 depicts, at 2000, a sequence of training screens that can be presented when the user 112 activates the tutorial control 1904 for snoozing alarms. For example, the gesture-training module 106 can present a training screen, illustrated in a detail view 2000-1, which explains how to perform the radar gesture for snoozing alarms. The training screen in the detail view 2000-1 illustrates a smartphone and an animation of a user's hand 112 above the smartphone. The smartphone also displays the visual feedback element 1808 and the sound control 1814. The training screen of the detail view 2000-1 also presents, in the text area 1810, text instructions explaining to the user how to “Snooze alarms” (e.g., “Swipe in any direction above the phone”). In some implementations, audio instruction may also be available (e.g., the user may select text, audio, or both, and select a default option, such as only text). An alarm icon 2002 (e.g., an alarm clock) may also be presented on the smartphone.

In another detail view 2000-2, the animation continues when the user reaches for the electronic device 102. In the continued animation, the animation of the user's hand disappears, and the smartphone displayed on the training screen shows the visual feedback element 1808, which expands when the user 112 reaches for the electronic device 102. The training screen continues to present the text area 1810 with the instructional text for how to snooze alarms. In the detail view 2000-2, the sound control 1814 is displayed with “sound on” text to illustrate how the user 112 can toggle the sound off and on with the sound control 1814. Another detail view 2000-3 illustrates the results of a partial gesture (e.g., a radar gesture that is unsuccessfully performed, as described above). In the detail view 2000-3, the animation continues by returning the visual feedback element 1808 to its original size and changing the instructional text presented in the text area 1810 (e.g., from “Swipe in any direction above the phone” to “Try a sweeping motion past both edges of the phone”). In some cases, audio or tactile (haptic) feedback may be included with the new textual instructions (e.g., a sound or haptic that indicates a rejected input).

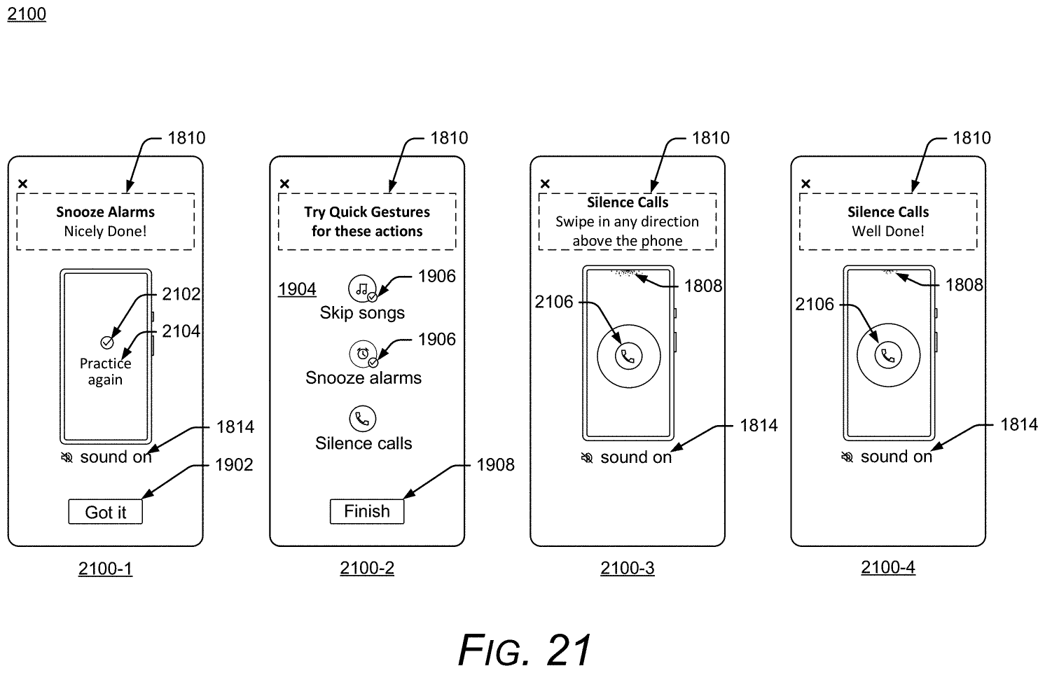

Another detail view 2000-4 illustrates the results of a successful swipe gesture (e.g., a swipe radar gesture, a direction-independent swipe, or an omni-swipe radar gesture) that is successfully performed, as described above). In the detail view 2000-4, the animation continues by causing the visual feedback element 1808 to collapse in on itself (e.g., as illustrated in FIG. 14). In the detail view 2000-4, the instructional text presented in the text area 1810 changes to provide the user 112 with feedback that the gesture was successful (e.g., “Nicely done!”). An audio or tactile (haptic) feedback may also be provided if available (e.g., a sound or haptic that indicates a confirmed input). The description of the tips tutorial for snoozing alarms continues in the following description of FIG. 21.

FIG. 21 illustrates, at 2100, additional training screens that may be presented in the tips tutorial for snoozing alarms. For example, a detail view 2100-1 illustrates additional elements of the training screen described in the detail view 2000-4 that is presented after the user successfully performs the swipe (e.g., a direction-independent swipe or omni-swipe). The training screen of the detail view 2100-1 illustrates the smartphone with the “Nicely done!” textual message displayed in the text area 1810, the return control 1902, which allows the user 112 to exit the snooze alarms tutorial (e.g., the “Got it” icon), and the sound control 1814. In some implementations, the training screen may also present the smartphone display with one or both of a completion icon 2102 (e.g., a checkmark) or a restart control 2104 (e.g., a “Practice again” icon).

Another detail view 2100-2 illustrates the training screen after the user 112 activates the return control 1902. In the detail view 2100-2, the animation ends, and the summary page is presented (e.g., the summary page described in the detail view 1900-4 of FIG. 19). The summary page can present text in the text area 1810 that reminds the user 112 that there are other gesture training options (“Try Quick Gestures for these actions”). The summary page can also present the tutorial controls 1904 that allow the user 112 to re-enter the tips environment for snoozing alarms or enter other tips tutorials for skipping songs and silencing calls. The summary page also includes the exit control 1908 that allows the user 112 to exit the tips tutorial environment (e.g., the “Finish” icon). The tutorial controls 1904 can be presented with the indicator 1906 (e.g., the check-mark icon), which lets the user 112 know which tutorials have been completed.

FIG. 21 also depicts, in a detail view 2100-3, a sequence of training screens that can be presented when the user 112 activates the tutorial control 1904 for silencing calls. For example, the gesture-training module 106 can present a sequence of training screens that explain how to perform the radar gesture for silencing calls. The training screen in the detail view 2100-3 illustrates a smartphone that is displaying the visual feedback element 1808 and the sound control 1814. The text displayed in the text area 1810 explains to the user how to silence calls (e.g., “Swipe in any direction above the phone”). In some implementations, audio instruction may also be available (e.g., the user may select text, audio, or both and select a default option, such as only text). In some cases, a phone call icon 2106 (e.g., a classic phone handset) may also be presented on the animated smartphone display.

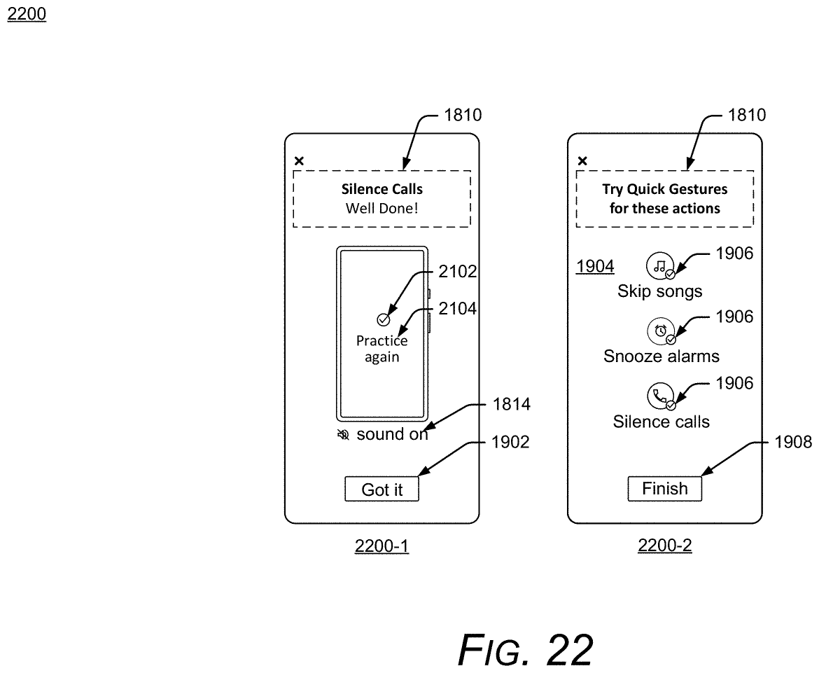

Another detail view 2100-4 illustrates the results of a successful swipe gesture (e.g., a swipe radar gesture, a direction-independent swipe, or an omni-swipe radar gesture) that is successfully performed, as described above). In the detail view 2100-4, the animation continues by causing the visual feedback element 1808 to collapse in on itself (e.g., as illustrated in FIGS. 14 and 20). In the detail view 2100-4, the instructional text presented in the text area 1810 changes to indicate the successful performance of the gesture (e.g., from “Swipe in any direction above the phone” to “Well done!”). The phone call icon 2106 and the sound control 1814 can also be displayed. An audio or tactile (haptic) feedback can also be provided if available (e.g., a system sound or haptic that indicates a confirmed input). The description of the tips tutorial for silencing calls continues in the following description of FIG. 22.

FIG. 22 illustrates, at 2200, additional training screens that may be presented in the tips tutorial for silencing calls. For example, a detail view 2200-1 illustrates additional elements of the training screen described in the detail view 2100-4 that is presented after the user successfully performs the swipe (e.g., a direction-independent swipe or omni-swipe). The training screen of the detail view 2200-1 illustrates a smartphone with the “Well done!” message presented in the text area 1810, the return control 1902, which allows the user 112 to exit the silence calls tutorial (e.g., the “Got it” icon), and the sound control 1814. In some implementations, the training screen may also present the smartphone display with one or both of the completion icon 2102 (e.g., a checkmark) or the restart control 2104 (e.g., the “Practice again” icon).

Another detail view 2200-2 illustrates the training screen after the user 112 activates the return control 2202. In the detail view 2200-2, the animation ends, and the summary page is presented (e.g., the summary page described in the detail view 1900-4 of FIG. 19). The summary page can include text in the text area 1810 that alerts the user 112 to other training options (e.g., “Try Quick Gestures for these action”) and the tutorial controls 1904 that allow the user 112 to re-enter the tips environment for silencing calls or enter other tips tutorials for skipping songs and snoozing alarms. The summary page also includes the exit control 1908, which allows the user 112 to exit the tips tutorial environment (e.g., the “Finish” icon). The tutorial controls can be presented with the indicator 1906 (e.g., the check-mark icon), which lets the user 112 know which tutorials have been completed. The techniques and examples described with reference to FIGS. 10-22 can enable the electronic device 102 and the radar system 104 to facilitate the user's proficiency, provide feedback to the user and, in some implementations, learn the user's preferences and habits (e.g., through the machine learning techniques described with reference to FIG. 9, which can be used with any of the described visual elements and visual feedback elements) to improve the performance, accuracy, and efficiency of the electronic device 102, the radar system 104, and the gesture-training module 106.

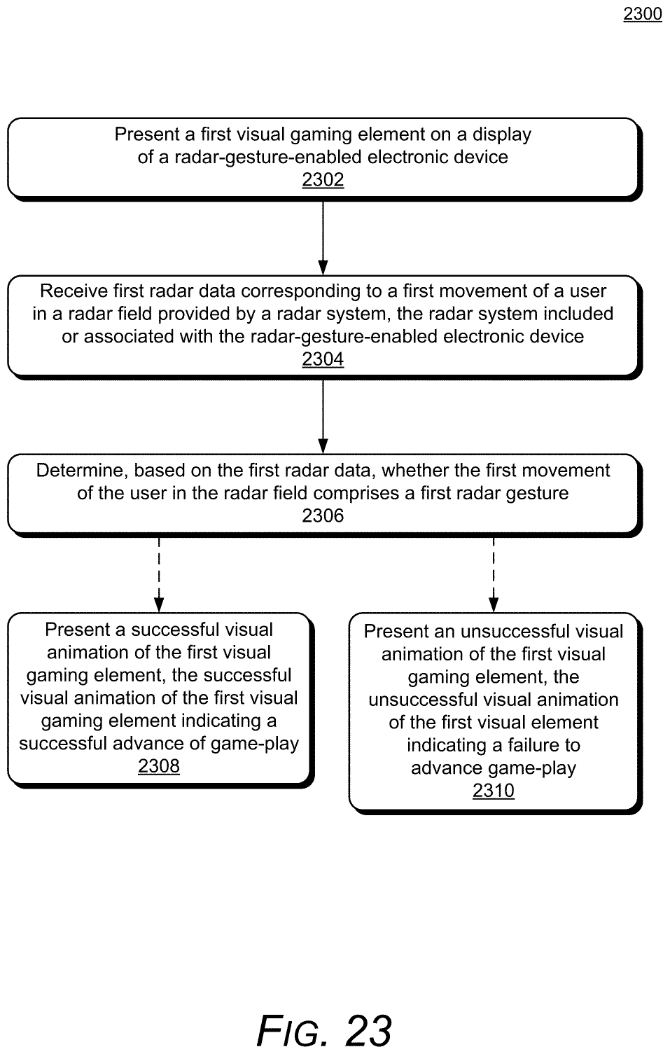

FIG. 23 illustrates method 2300, which is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example operating environment 100 of FIG. 1 or to entities or processes as detailed in FIGS. 2-22, reference to which is made for example only. The techniques are not limited to performance by one entity or multiple entities operating on one device.

At block 2302, a visual gaming element is presented on a display of a radar-gesture-enabled electronic device. For example, the gesture-training module 106 can present the visual gaming element 124 (which can include the visual gaming element 124-1) on the display 114 of the electronic device 102. The visual gaming element 124 can be any of a variety of suitable elements that the user 112 can interact with as part of a game or gaming environment (e.g., using a gesture, such as a radar-gesture). In some cases, for example, the visual gaming element 124 can be a character (e.g., a Pikachu, a hero, a creature, or an adventurer) or a vehicle (e.g., a race car or an aircraft). In other cases, the visual gaming element 124 can be a set of objects, such as a ball and a dog, a basketball and basket, or a mouse in a maze, with which the user 112 can interact using gestures. Additionally, the visual gaming element may include instructions (textual, non-textual, or implicit, as described with reference to the method 900) that describe game play, describe the gestures that can be used to interact with the visual gaming element 124, or request the user to perform a particular gesture.

In some cases, the instructions, or the visual gaming element itself, can include a request for a user to perform a gesture proximate to the electronic device. The requested gesture can be a radar-based touch-independent radar gesture (as described above), a touch gesture (e.g., on a touch screen), or another kind of gesture, such as a camera-based touch-independent gesture.

At 2304, radar data corresponding to a movement of a user in a radar field provided by a radar system is received. The radar system may be included or associated with the electronic device, and the movement can be proximate to the electronic device. For example, the radar system 104, as described with reference to FIGS. 1-8, may provide the radar data.

At 2306, it is determined, based on the radar data, whether the movement of the user in the radar field comprises a gesture (e.g., the gesture of which the instructions described or requested performance). For example, the gesture-training module 106 can determine whether the movement of the user in the radar field 110 includes or is a radar gesture (e.g., a radar-based touch-independent gesture, as described above).

In some implementations, as described above, the gesture-training module 106 can determine whether the movement of the user in the radar field 110 is a radar gesture by using the radar data to detect values of a set of parameters that are associated with the movement of the user in the radar field. For example, the set of parameters can include values representing one or more of a shape or a path of the movement of the user, a length or a velocity of the movement, or a distance of the user from the electronic device 102. The gesture-training module 106 then compares the values of the set of parameters to benchmark values for the set of parameters. For example, the gesture-training module 106 can compare the values for the set of parameters to benchmark values that are stored by the gesture library 120, as described above.

When the values of the set of parameters associated with the movement of the user meet the criteria defined by the benchmark parameters, the gesture-training module 106 determines that the movement of the user in the radar field is or includes a radar gesture. Alternately, when the values of the set of parameters associated with the movement of the user do not meet the criteria defined by the benchmark parameters, the gesture-training module 106 determines that the movement of the user in the radar field is not or does not include a radar gesture. As described, the gesture-training module 106 may use a range of benchmark values that allow some variation in the values of the set of parameters cause the gesture-training module 106 to determine that the movement of the user is a radar gesture. Additional details related to techniques for determining whether a movement of a user is the gesture are described with reference to FIG. 9.

Further, in some implementations described above, the electronic device 102 may include machine-learning techniques that can generate adaptive or adjusted benchmark values associated with the first gesture of which the instructions requested performance. Then, when the gesture-training module 106 receives radar data corresponding to the user's movement in the radar field, the gesture-training module 106 can compare the detected values to the adjusted benchmark values and determine whether the movement of the user is a radar gesture. Because the adjusted parameters are based on a machine-learned set of parameters, the user's gesture can be determined to be the requested radar gesture, even when the user's gestures would not be the requested gesture based on a comparison to unadjusted benchmark values. Thus, the adjusted benchmark values allow the electronic device and the gesture-training module 106 to learn to accept more variation in how user's make radar gestures (e.g., when the variation is consistent). Additional details related to the use of the machine-learning techniques are described with reference to FIG. 9.

Optionally at 2308, in response to determining that the movement of the user in the radar field is or includes the radar gesture (e.g., the gesture of which the instructions requested performance), a successful visual animation of the visual gaming element is presented on the display. The successful visual animation of the visual gaming element indicates a successful advance of game-play, a positive result, or other positive feedback (e.g., presenting text, such as “good job!” or a visual character, e.g., such as an animal or a Pokemon™ character (e.g., a Pikachu™), smiling, jumping, or otherwise behaving in a positive manner). Thus, a visual feedback element (e.g., visual animation) is presented on the display. The visual animation or visual feedback element indicates that the movement of the user in the radar field is the radar gesture of which the instructions requested performance. For example, in response to the determination that the user's movement is the requested radar gesture, the gesture-training module 106 can present a successful visual animation of the visual gaming element 124 on the display 114.

Optionally at 2310, in response to determining that the movement of the user in the radar field is not or does not include the radar gesture, an unsuccessful visual animation of the visual gaming element is presented on the display. The unsuccessful visual animation of the visual element indicates a failure to advance game-play, an unsuccessful advance of game-play, a negative result, or other negative feedback (presenting text of “try again!” or a visual character, e.g., an animal or a Pokemon™ character (e.g., a Pikachu™) that is waiting, showing a sad face, or otherwise behaving in a neutral or negative manner, or any non-positive response that is different from the response to a determination of a successful gesture). For example, in response to the determination that the user's movement is not the requested radar gesture, the gesture-training module 106 can present an unsuccessful visual animation of the visual gaming element 124 on the display 114.

When the user 112 fails to make a successful gesture (e.g., the gesture-training module 106 determines that the user's movement is not the radar gesture, as described above), and the gesture-training module 106 presents the unsuccessful visual animation of the visual gaming element, the user 112 may attempt the radar gesture again (e.g., of the user's own volition or in response to instructions, such as the text instructions that can be displayed in the text area 1810, as described above). When the user 112 attempts the gesture again, the radar system generates corresponding radar data and the electronic device 102 (using, for example, the radar system 104 and/or the gesture-training module 106) can determine that the user's movement is the radar gesture and present the successful visual animation of the visual gaming element 124 on the display 114. Additionally, after the gesture-training module 106 determines that the user's movement is the radar gesture (e.g., after a first, second, or subsequent attempt), the gesture-training module 106 can present another successful visual animation of the visual gaming element, thereby advancing game-play.

The other successful visual animation of the visual gaming element can advance game-play such that a visual gaming element is presented (e.g., the original visual gaming element or a new visual gaming element). The visual gaming element may include instructions (textual, non-textual, or implicit, as described with reference to the method 900) that describe game play, describe the gestures that can be used to interact with the visual gaming element, or request the user to perform a particular gesture. This process of gesturing and advancing or not advancing game play based on the user's performance can be repeated, with different visual gaming elements and different successful and unsuccessful visual animations of the visual gaming elements.

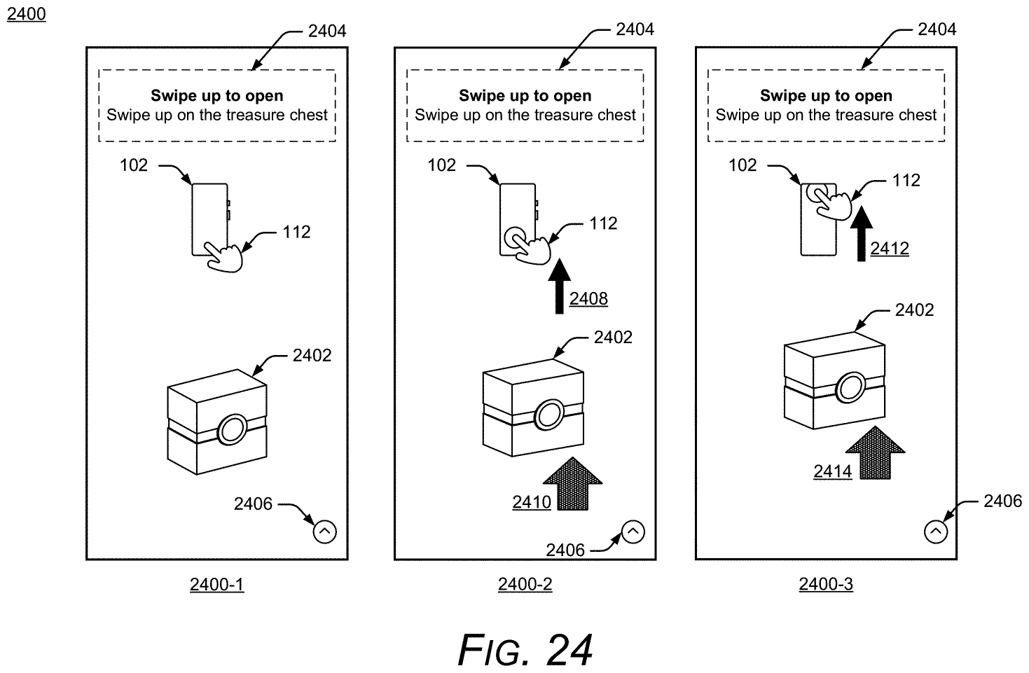

The different visual gaming elements and different successful and unsuccessful visual animations of the visual gaming elements can be associated with different gestures, such as direction-dependent gestures (e.g., left-to-right swipe, right-to-left swipe, bottom-to-top swipe, or top-to-bottom swipe) or direction-independent gestures (e.g., the omni-swipe described above). Thus, the electronic device 102 can use the game environment to teach the user gestures or allow the user to practice gestures, in a delightful and efficient manner. By way of example, consider the following FIGS. 24-33, which illustrate various examples of successful and unsuccessful visual animations of the visual gaming element 124.

FIG. 24 depicts, at 2400, a sequence of training screens that can be presented when the user 112 enters the gaming environment described with reference to FIG. 23. Consider a simple game in which the user performs a gesture, or series of gestures, to open a treasure chest. Alternately or additionally, the gaming environment may employ other common objects with simple or intuitive manipulations, such as toggle switches, rotary dials, slide controls, book pages, or the like. The gesture can be any suitable type of gesture, such as a radar-based touch-independent radar gesture (as described above), a touch gesture (e.g., a touch gesture performed on a touch screen), or another kind of gesture, such as a camera-based touch-independent gesture), for this example, assume the game gestures are radar gestures.

For example, the gesture-training module 106 can present a training-game screen (training screen), illustrated in a detail view 2400-1, which explains how to perform the gesture to open a treasure chest 2402. The training screen in the detail view 2400-1 illustrates an example smartphone 102 and an animation of a user's hand 112 near the smartphone. The training screen of the detail view 2400-1 also includes a text area 2404 (shown as a dashed-line rectangle), which can display text that instructs the user to perform a radar gesture to play the game or manipulate the game element (e.g., “Swipe up on the treasure chest” or “Swipe up above the smartphone”). The text area 2404 can also be used to display a title for the tutorial or an explanation of what action will result from a successful gesture (e.g., “Swipe up to open”). In some implementations, audio instructions may also be available (e.g., the user may select text, audio, or both and select a default option, such as only text). In some implementations, the game environment also includes an exit control 2406, which allows the user to exit the training screens and the game environment to return to normal operation of the electronic device 102.

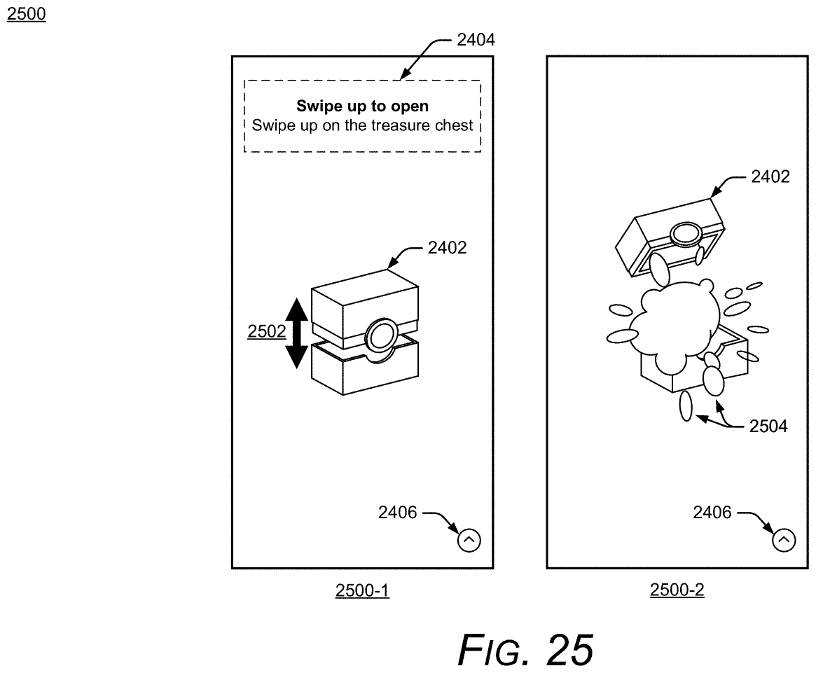

An animation sequence begins in another detail view 2400-2, in which the user 112 begins to make the requested gesture (swipe up), as shown by an arrow 2408. As the user begins the gesture, the treasure chest 2402 begins to rise, as shown by another arrow 2410. The animation continues in a detail view 2400-3, in which the gesture continues (shown by an arrow 2412) as the user's hand reaches the top of the example smartphone 102 and the treasure chest 2402 continues to rise (as shown by an arrow 2414). The description of the training screens in the treasure chest gaming environment continues in the following description of FIG. 25.

FIG. 25 illustrates, at 2500, additional training screens that may be presented in the treasure chest gaming environment. In this example, the additional training screens illustrate the result of a successful “swipe up” radar gesture (e.g., a successful animation of the visual gaming element, as described with reference to FIG. 23). For example, a detail view 2500-1 shows the treasure chest 2402 beginning to open (shown by a double-ended arrow 2502). The detail view 2500-1 also includes the text area 2404 with the text instructions. In another detail view 2500-2, the successful animation continues, as the text instructions disappear and the treasure chest 2402 explodes open, releasing treasure coins 2504.

In both detail views 2500-1 and 2500-2, the training screen includes the optional exit control 2406. Further, in the training screens presented in FIGS. 24 and 25, an audio or tactile (haptic) feedback may also be provided if available (e.g., a sound or haptic that indicates a confirmed input). In the case of the user making an unsuccessful gesture (not illustrated), the treasure chest 2402 does not rise or open, and the gesture-training module 106 may present another animation that shows the failed gesture attempt, such as the treasure chest 2402 being carried away by the tide or sinking into the ground (e.g., the gesture-training module 106 may present an unsuccessful animation of the visual gaming element, as described with reference to FIG. 23).

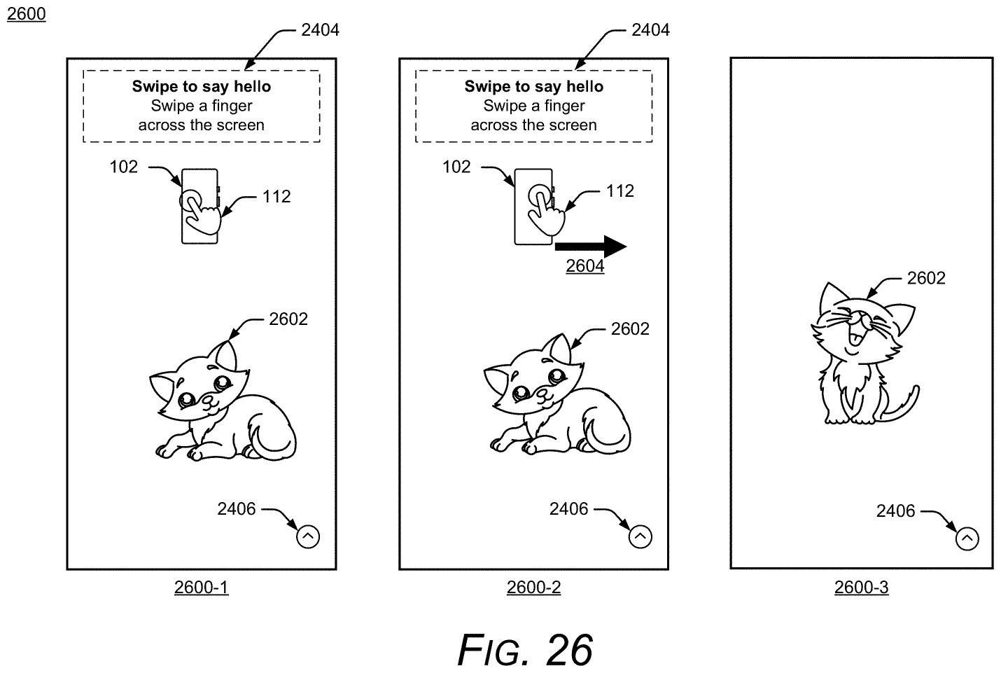

FIG. 26 illustrates, at 2600, another sequence of training screens that can be presented when the user 112 enters the gaming environment described with reference to FIG. 23. For example, consider a game in which the user performs a gesture, or series of gestures, to say hello to a pet 2602 (e.g., a cat, a dog, or a Pikachu™). The gesture can be any suitable type of gesture, such as a radar-based touch-independent radar gesture (as described above), a touch gesture (e.g., a touch gesture performed on a touch screen), or another kind of gesture, such as a camera-based touch-independent gesture), for this example, assume the game gestures are radar gestures.

For example, the gesture-training module 106 can present a training-game screen (training screen), illustrated in a detail view 2600-1, which explains how to perform the gesture to say hello to the pet 2602 (in this case, a kitten). The training screen in the detail view 2600-1 illustrates an example smartphone 102 and an animation of a user's hand 112 near the smartphone. The training screen of the detail view 2600-1 also includes the text area 2404 (shown as a dashed-line rectangle), which can display text that instructs the user to perform a radar gesture to play the game (e.g., “Swipe a finger across the screen” or “Swipe left or right above the phone”). The text area 2404 can also be used to display a title for the tutorial or an explanation of the purpose of (or what action will result from) a successful gesture (e.g., “Swipe to say hello”). In some implementations, audio instructions may also be available (e.g., the user may select text, audio, or both and select a default option, such as only text). In some implementations, the game environment also includes an exit control 2406, which allows the user to exit the training screens and the game environment to return to normal operation of the electronic device.

In another detail view 2600-2, the user 112 begins to make the requested gesture (swipe across the screen), as shown by an arrow 2604. The pet 2602 and the exit control 2406 are also presented on the training screen in the detail view 2600-2. The animation (e.g., the unsuccessful animation of the visual gaming element, as described with reference to FIG. 23) continues in a detail view 2600-3, in which the pet 2602 sits up and opens its mouth (e.g., says “hello”). In the detail views 2600-1 through 2600-3, an audio or tactile (haptic) feedback may also be provided if available (e.g., a sound or haptic that indicates a successful gesture). In the case of the user making an unsuccessful gesture (not illustrated), the pet 2602 does not say “hello,” and the gesture-training module 106 may present another animation that shows the failed gesture attempt, such as the pet 2602 walking away or going to sleep (e.g., the gesture-training module 106 may present an unsuccessful animation of the visual gaming element, as described with reference to FIG. 23).

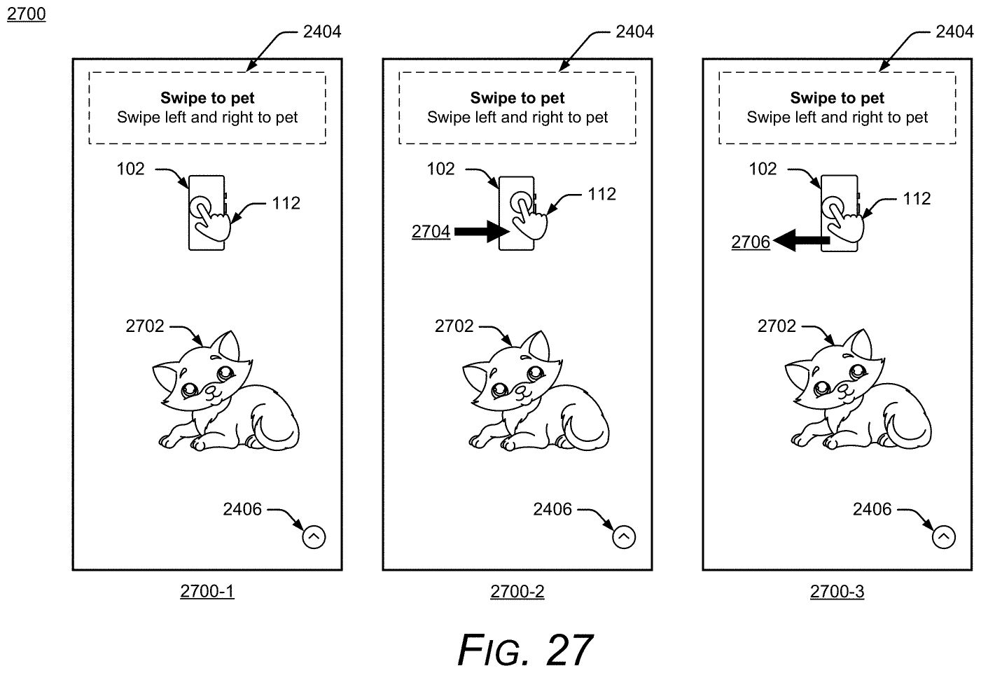

FIG. 27 illustrates, at 2700, another sequence of training screens that can be presented when the user 112 enters the gaming environment described with reference to FIG. 23. For example, consider a game in which the user performs a gesture, or series of gestures, to pet an animal or pet 2702 (e.g., a cat, a ferret, or a Pikachu™). The gesture can be any suitable type of gesture, such as a radar-based touch-independent radar gesture (as described above), a touch gesture (e.g., a touch gesture performed on a touch screen), or another kind of gesture, such as a camera-based touch-independent gesture), for this example, assume the game gestures are radar gestures.

For example, the gesture-training module 106 can present a training-game screen (training screen), illustrated in a detail view 2700-1, which explains how to perform the gesture to pet the animal or pet 2702 (in this case, a cat 2702). The training screen in the detail view 2700-1 illustrates an example smartphone 102 and an animation of a user's hand 112 near the smartphone. The training screen of the detail view 2700-1 also includes the text area 2404 (shown as a dashed-line rectangle), which can display text that instructs the user to perform a radar gesture to play the game (e.g., “Swipe left and right to pet” or “Drag finger left and right to pet” or “Swipe left or right above the phone”). The text area 2404 can also be used to display a title for the tutorial or an explanation of the purpose of (or what action will result from) a successful gesture (e.g., “Swipe to pet”). In some implementations, audio instructions may also be available (e.g., the user may select text, audio, or both and select a default option, such as only text). In some implementations, the game environment also includes an exit control 2406, which allows the user to exit the training screens and the game environment to return to normal operation of the electronic device.

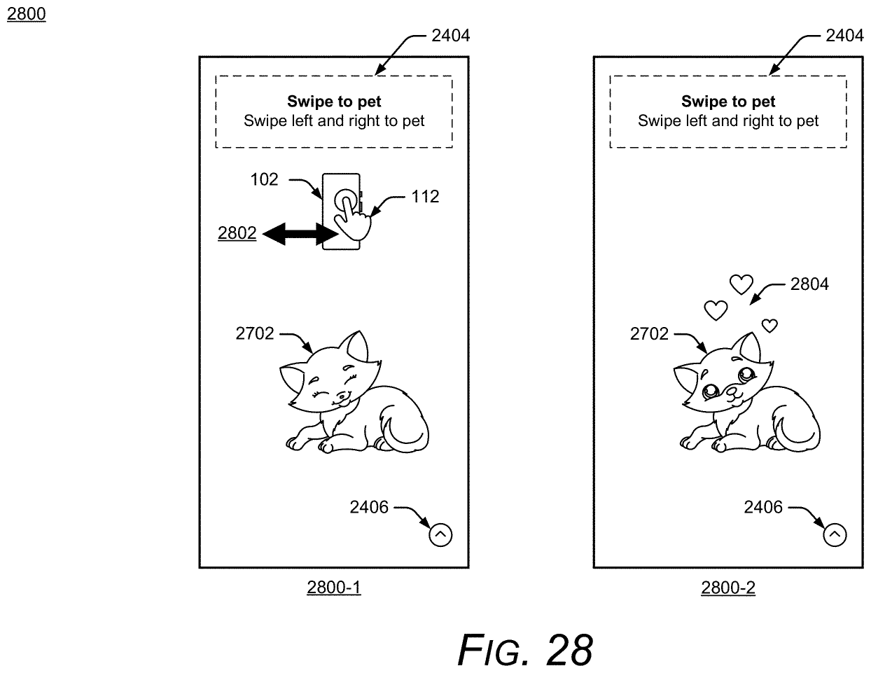

In another detail view 2700-2, the user 112 begins to make the first part of the requested gesture (swipe right above the screen), as shown by an arrow 2704. The cat 2702 and the exit control 2406 are also presented on the training screen in the detail view 2700-2. The animation continues in a detail view 2700-3, which shows the user making the second apart of the requested gesture (swipe left above the screen), as shown by another arrow 2706. The training screens in the detail views 2700-2 and 2700-3 also illustrate the text area 2404 (with instructions) and the exit control 2406. In the detail views 2700-1 through 2700-3, an audio or tactile (haptic) feedback may also be provided if available (e.g., a sound or haptic that indicates a successful gesture) The description of the training screens in the swipe-to-pet gaming environment continues in the following description of FIG. 28.

FIG. 28 illustrates, at 2800, additional training screens that may be presented in the swipe-to-pet gaming environment. In this example, the additional training screens illustrate the result of a successful “swipe left and right” gesture (e.g., a successful animation of the visual gaming element, as described with reference to FIG. 23). For example, a detail view 2800-1 shows the cat 2702 close its eyes and change its facial expression. The detail view 2800-1 also includes the text area 2404 with the text instructions. The user 112 continues to swipe left and right, as shown by a double-ended arrow 2802.

In another detail view 2800-2, the successful animation continues, as the cat 2702 opens its eyes and animated hearts 2804 appear above the cat 2702. In both detail views 2800-1 and 2800-2, the training screens includes the optional exit control 2406. Further, in the training screens presented in FIG. 28, an audio or tactile (haptic) feedback may also be provided if available (e.g., a sound or haptic that indicates a confirmed input). In the case of the user making an unsuccessful gesture (not illustrated), the cat 2702 does not close its eyes, and no hearts are presented. Further, the gesture-training module 106 may present another animation that shows the failed gesture attempt, such as the cat 2702 walking away or going to sleep (e.g., the gesture-training module 106 may present an unsuccessful animation of the visual gaming element, as described with reference to FIG. 23).

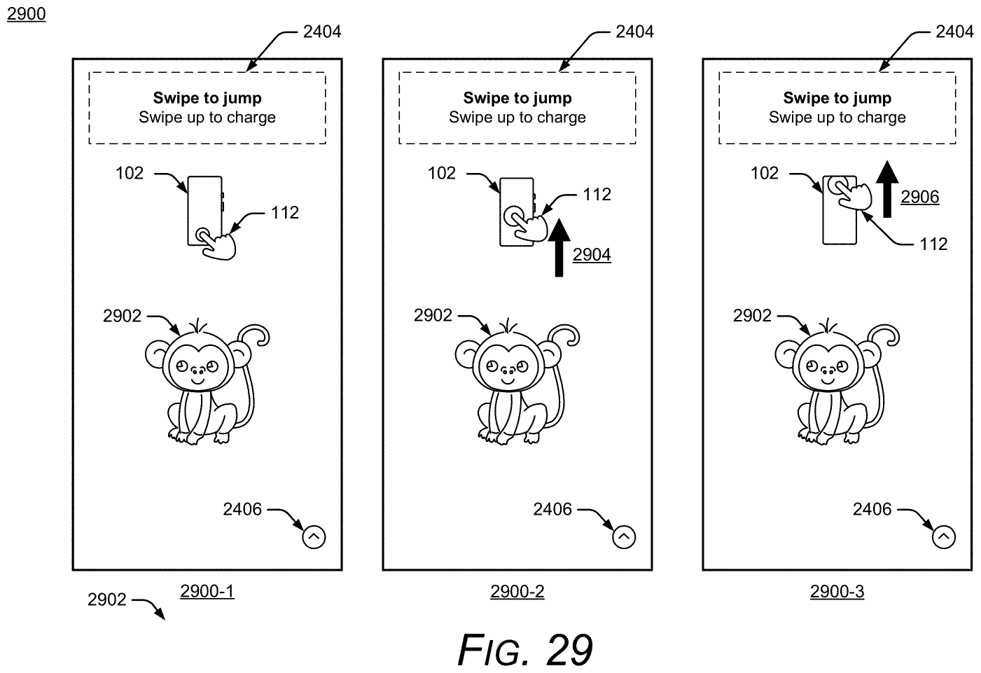

FIG. 29 illustrates, at 2900, another sequence of training screens that can be presented when the user 112 enters the gaming environment described with reference to FIG. 23. For example, consider a game in which the user performs a gesture, or series of gestures, to cause a character or an animal 2902 (e.g., a lemur, a cat, or a Pikachu™). The gesture can be any suitable type of gesture, such as a radar-based touch-independent radar gesture (as described above), a touch gesture (e.g., a touch gesture performed on a touch screen), or another kind of gesture, such as a camera-based touch-independent gesture), for this example, assume the game gestures are radar gestures.

For example, the gesture-training module 106 can present a training-game screen (training screen), illustrated in a detail view 2900-1, which explains how to perform the gesture to pet the character or animal 2902 (in this case, a lemur 2902). The training screen in the detail view 2900-1 illustrates an example smartphone 102 and an animation of a user's hand 112 near the smartphone. The training screen of the detail view 2900-1 also includes the text area 2404 (shown as a dashed-line rectangle), which can display text that instructs the user to perform a radar gesture to play the game (e.g., “Swipe up to charge” or “Swipe up to spring”). The text area 2404 can also be used to display a title for the tutorial or an explanation of the purpose of (or what action will result from) a successful gesture (e.g., “Swipe to jump”). In some implementations, audio instructions may also be available (e.g., the user may select text, audio, or both and select a default option, such as only text). In some implementations, the game environment also includes an exit control 2406, which allows the user to exit the training screens and the game environment to return to normal operation of the electronic device.

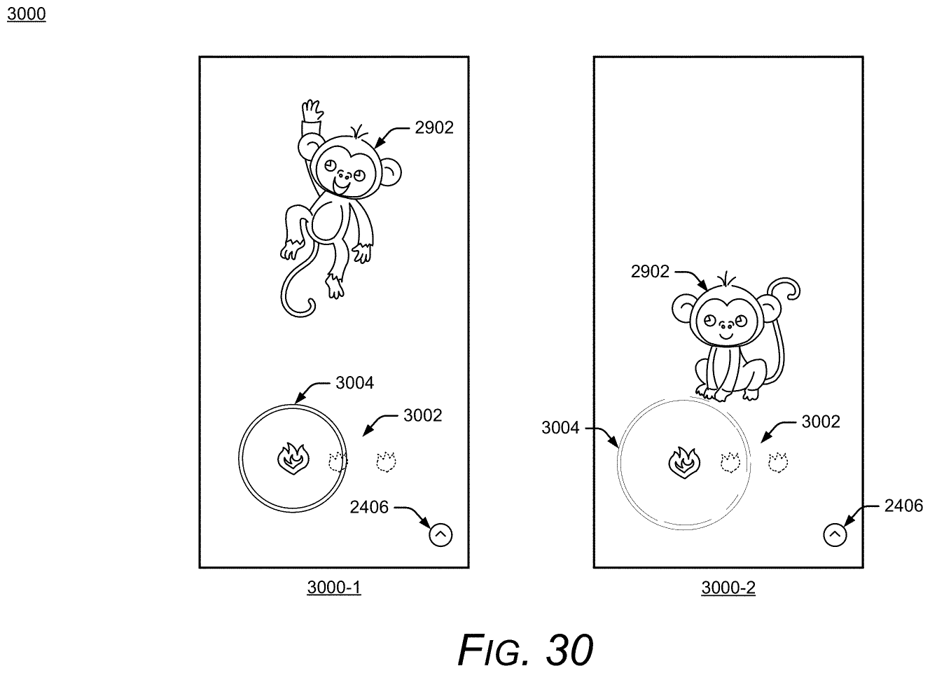

In another detail view 2900-2, the user 112 begins to make the requested gesture (swipe up above the screen), as shown by an arrow 2904. The lemur 2902 and the exit control 2406 are also presented on the training screen in the detail view 2900-2. The animation continues in a detail view 2900-3, which shows that the user continues to make the requested gesture, as shown by another arrow 2906. The training screens in the detail views 2900-2 and 2900-3 also illustrate the text area 2404 (with instructions) and the exit control 2406. The description of the training screens in the swipe-to-jump gaming environment continues in the following description of FIG. 30.

FIG. 30 illustrates, at 3000, additional training screens that may be presented in the swipe-to-jump gaming environment. In this example, the additional training screens illustrate the result of a successful “swipe up” gesture (e.g., a successful animation of the visual gaming element, as described with reference to FIG. 23). For example, a detail view 3000-1 shows the lemur 2902 change its facial expression and jump into the air. The detail view 3000-1 also includes game-play indicators 3002, illustrated as small flames. The game-play indicators 3002 show the user how many times to make the lemur jump to complete the game. In the example of the detail view 3000-1, a first jump has been completed, as shown by the leftmost game-play indicator 3002 being shown larger and with a halo 3004.

In another detail view 3000-2, the successful animation continues, as the lemur 2902 returns to the ground and returns to its original facial expression. Additionally, the halo 3004 is fading, as shown by thinner and partially broken lines. In both detail views 3000-1 and 3000-2, the training screens include the optional exit control 2406. Further, in the training screens presented in FIGS. 29 and 30, an audio or tactile (haptic) feedback may also be provided if available (e.g., a sound or haptic that indicates a successful gesture). In the case of the user making an unsuccessful gesture (not illustrated), the lemur 2902 does not jump and the gesture-training module 106 may present another animation that shows the failed gesture attempt, such as the lemur 2902 shrugging its shoulders or lying down to sleep (e.g., the gesture-training module 106 may present an unsuccessful animation of the visual gaming element, as described with reference to FIG. 23).

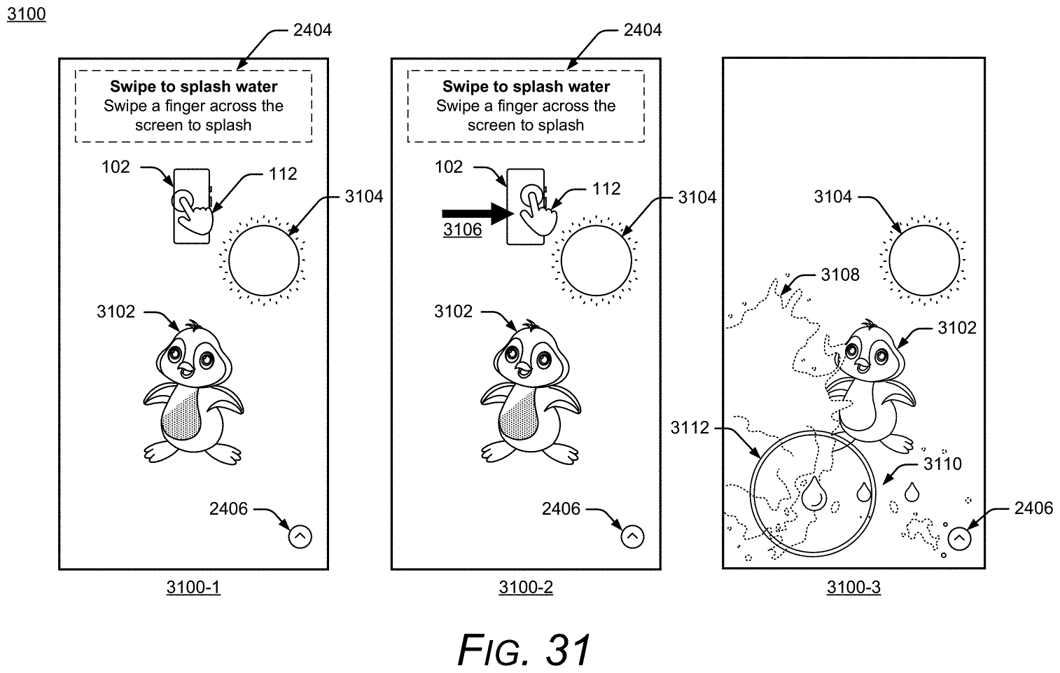

FIG. 31 illustrates, at 3100, another sequence of training screens that can be presented when the user 112 enters the gaming environment described with reference to FIG. 23. For example, consider a game in which the user performs a gesture, or series of gestures, to splash a penguin 3102 (or another character, such as a cat, a dog, or a Pikachu™). The gesture can be any suitable type of gesture, such as a radar-based touch-independent radar gesture (as described above), a touch gesture (e.g., a touch gesture performed on a touch screen), or another kind of gesture, such as a camera-based touch-independent gesture), for this example, assume the game gestures are radar gestures.

For example, the gesture-training module 106 can present a training-game screen (training screen), illustrated in a detail view 3100-1, which explains how to perform the gesture to splash water on the penguin 3102. The training screen in the detail view 3100-1 illustrates an example smartphone 102 and an animation of a user's hand 112 near the smartphone. The training screen of the detail view 3100-1 also includes the text area 2404 (shown as a dashed-line rectangle), which can display text that instructs the user to perform a radar gesture to play the game (e.g., “Swipe a finger across the screen to splash” or “Swipe left or right above the phone”). The text area 2404 can also be used to display a title for the tutorial or an explanation of the purpose of (or what action will result from) a successful gesture (e.g., “Swipe to splash water”).

In this example, the training screen also includes the sun 3104, which can help the user understand that the object of the game is to cool the penguin 3102 by splashing water on it. In some implementations, audio instructions may also be available (e.g., the user may select text, audio, or both and select a default option, such as only text). The game environment also includes an exit control 2406, which allows the user to exit the training screens and the game environment to return to normal operation of the electronic device.

In another detail view 3100-2, the user 112 begins to make the requested gesture (swipe across or above the screen), as shown by an arrow 3106. The penguin 3102, the sun 3104, and the exit control 2406 are also presented on the training screen in the detail view 3100-2. The animation (e.g., the successful animation of the visual gaming element, as described with reference to FIG. 23) continues in a detail view 3100-3, in which a splash 3108 washes over the penguin 3102. The detail view 3100-3 also includes game-play indicators 3110, illustrated as small drops. The game-play indicators 3110 show the user how many times to splash the penguin to complete the game. In the example of the detail view 3100-3, a first splash has been completed, as shown by the leftmost game-play indicator 3110 being shown larger and with a halo 3112.

In the detail views 3100-1 through 3100-3, an audio or tactile (haptic) feedback may also be provided if available (e.g., a sound or haptic that indicates a successful gesture). In the case of the user making an unsuccessful gesture (not illustrated), the penguin 3102 does not get splashed, and the gesture-training module 106 may present another animation that shows the failed gesture attempt, such as the penguin 3102 walking or swimming away or crying (e.g., the gesture-training module 106 may present an unsuccessful animation of the visual gaming element, as described with reference to FIG. 23).

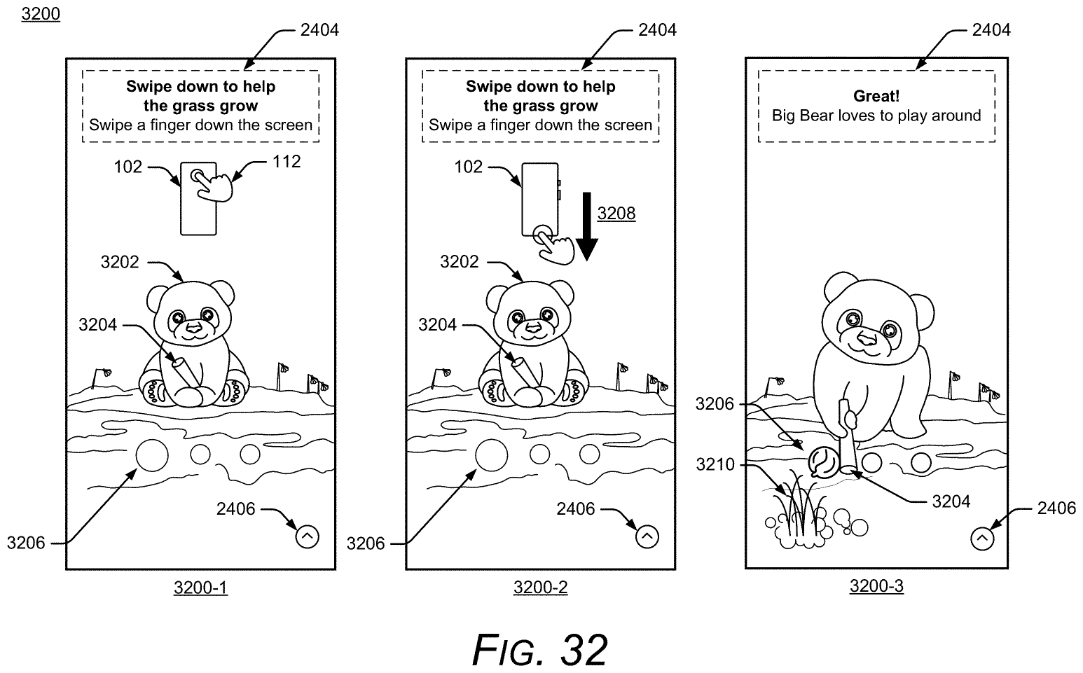

FIG. 32 illustrates, at 3200, another sequence of training screens that can be presented when the user 112 enters the gaming environment described with reference to FIG. 23. For example, consider a game in which the user performs a gesture, or series of gestures, to cause a bear 3202 (or another character, such as a cat, a dog, or a mythological or fictional character) to make grass grow with a magic wand 3204. The gesture can be any suitable type of gesture, such as a radar-based touch-independent radar gesture (as described above), a touch gesture (e.g., a touch gesture performed on a touch screen), or another kind of gesture, such as a camera-based touch-independent gesture), for this example, assume the game gestures are radar gestures.

For example, the gesture-training module 106 can present a training-game screen (training screen), illustrated in a detail view 3200-1, which explains how to perform the gesture to get the bear 3202 to use the wand 3204. The training screen in the detail view 3200-1 illustrates an example smartphone 102 and an animation of a user's hand 112 near the smartphone. The training screen of the detail view 3200-1 also includes the text area 2404 (shown as a dashed-line rectangle), which can display text that instructs the user to perform a radar gesture to play the game (e.g., “Swipe a finger down the screen” or “Swipe down above the phone”). The text area 2404 can also be used to display a title for the tutorial or an explanation of the purpose of (or what action will result from) a successful gesture (e.g., “Swipe down to help the grass grow”).

In this example, the training screen also includes game-play indicators 3206, illustrated as small circles. The game-play indicators 3206 show the user how many times to make the bear 3202 use the wand 3204 to complete the game. In some implementations, audio instructions may also be available (e.g., the user may select text, audio, or both and select a default option, such as only text). The game environment also includes an exit control 2406, which allows the user to exit the training screens and the game environment to return to normal operation of the electronic device.

In another detail view 3200-2, the user 112 begins to make the requested gesture (swipe down above the screen), as shown by an arrow 3208. The bear 3202, the wand 3204, the game-play indicators 3206, and the exit control 2406 are also presented on the training screen in the detail view 3200-2. The animation (e.g., the successful animation of the visual gaming element, as described with reference to FIG. 23) continues in a detail view 3200-3, in which the bear 3202 begins to hit the ground with the wand 3204 and the grass 3210 grows (e.g., the user swipes down and the bear 3202 hits the ground). In the detail view 3200-3, the text in the text area 2404 has changed to let the user 112 know that the attempted gesture was successful (e.g., “Great! Big Bear loves to play around”). The detail view 3200-3 also includes the game-play indicators 3206 and the exit control 2406. In the example of the detail view 3200-3, a first growth of grass has been completed, as shown by the leftmost game-play indicator 3206 being shown larger than the other game-play indicators 3206.

In the detail views 3200-1 through 3200-3, an audio or tactile (haptic) feedback may also be provided if available (e.g., a sound or haptic that indicates a successful gesture). In the case of the user making an unsuccessful gesture (not illustrated), the bear 3202 does not use the wand 3204 to grow the grass 3210, and the gesture-training module 106 may present another animation that shows the failed gesture attempt, such as the bear 3202 walking away or going to sleep (e.g., the gesture-training module 106 may present an unsuccessful animation of the visual gaming element, as described with reference to FIG. 23).

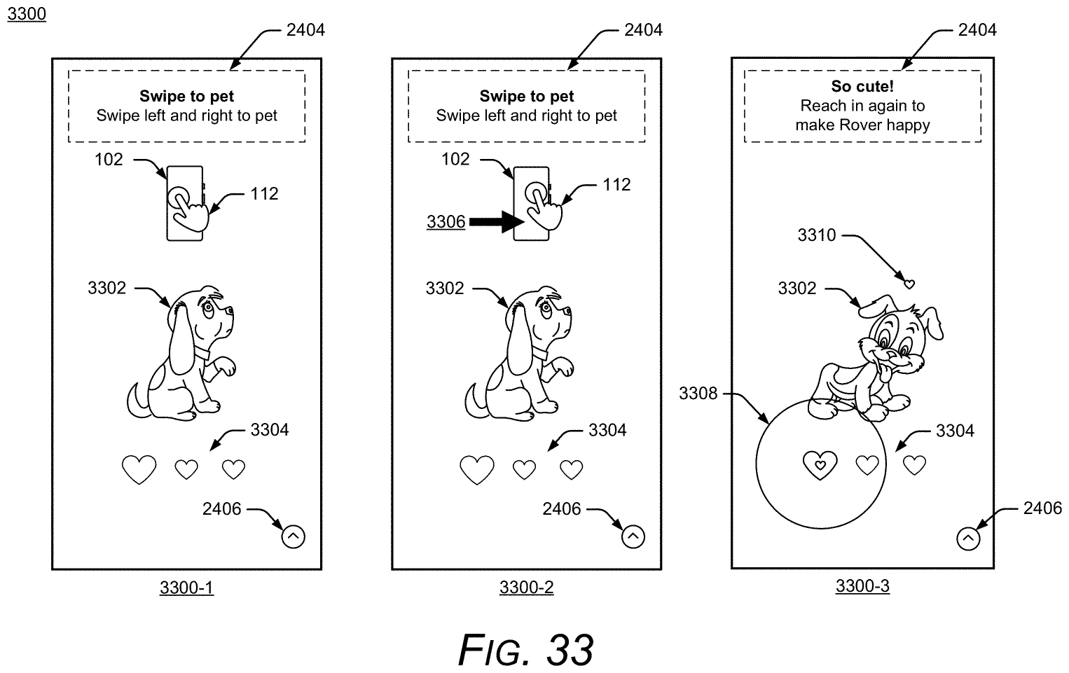

FIG. 33 illustrates, at 3300, another sequence of training screens that can be presented when the user 112 enters the gaming environment described with reference to FIG. 23. For example, consider a game in which the user performs a gesture, or series of gestures, to pet or tickle a dog 3302 (or another character, such as a cat or a lizard). The gesture can be any suitable type of gesture, such as a radar-based touch-independent radar gesture (as described above), a touch gesture (e.g., a touch gesture performed on a touch screen), or another kind of gesture, such as a camera-based touch-independent gesture), for this example, assume the game gestures are radar gestures.

For example, the gesture-training module 106 can present a training-game screen (training screen), illustrated in a detail view 3300-1, which explains how to perform the gesture to pet the dog 3302. The training screen in the detail view 3300-1 illustrates an example smartphone 102 and an animation of a user's hand 112 near the smartphone. The training screen of the detail view 3300-1 also includes the text area 2404 (shown as a dashed-line rectangle), which can display text that instructs the user to perform a radar gesture to play the game (e.g., “Swipe left and right to pet” or “Swipe left and right above the phone” or “reach in and move your fingers to tickle”). The text area 2404 can also be used to display a title for the tutorial or an explanation of the purpose of (or what action will result from) a successful gesture (e.g., “Swipe to pet” or “Wave your fingers to tickle”).

In this example, the training screen also includes game-play indicators 3204, illustrated as hearts. The game-play indicators 3204 show the user how many times to pet the dog 3302 to complete the game. In some implementations, audio instructions may also be available (e.g., the user may select text, audio, or both and select a default option, such as only text). The game environment also includes an exit control 2406, which allows the user to exit the training screens and the game environment to return to normal operation of the electronic device.

In another detail view 3300-2, the user 112 begins to make the requested gesture (swipe left and right across or above the screen), as shown by an arrow 3306. The dog 3302, the game-play indicators 3304, and the exit control 2406 are also presented on the training screen in the detail view 3300-2. The animation (e.g., the successful animation of the visual gaming element, as described with reference to FIG. 23) continues in a detail view 3300-3, in which the dog 3302 changes its posture and facial expression to indicate a successful gesture (e.g., a swipe or tickle). The detail view 3300-3 also includes the exit control 2406 and the game-play indicators 3304. In this case, the game-play indicators 3304 show the user that a first pet has been completed, as shown by the leftmost game-play indicator 3304 being shown larger and surrounded with a halo 3308. Additionally, to help the user understand that the radar gesture was successful, the gesture-training module 106 presents a small heart 3310 above the dog 3302. Further, to let the user know to play again, the text in the text area 2404 changes (e.g., from “Swipe to pet” and “Swipe left and right to pet” to “So cute! Reach again to make Rover happy” or “Reach in again and move your fingers to tickle Rover”).

In the detail views 3300-1 through 3300-3, an audio or tactile (haptic) feedback may also be provided if available (e.g., a sound or haptic that indicates a successful gesture). In the case of the user making an unsuccessful gesture (not illustrated), the dog 3302 does not change its posture or facial expression, and the gesture-training module 106 may present another animation that shows the failed gesture attempt, such as the dog 3302 walking or going to sleep (e.g., the gesture-training module 106 may present an unsuccessful animation of the visual gaming element, as described with reference to FIG. 23).

Example Computing System

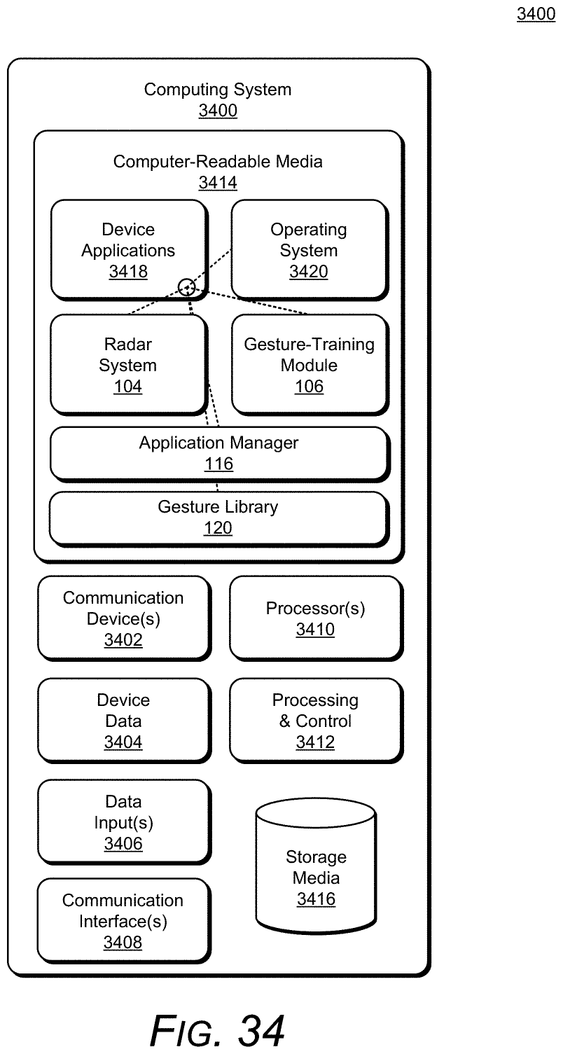

FIG. 34 illustrates various components of an example computing system 3400 that can be implemented as any type of client, server, and/or electronic device as described with reference to the previous FIGS. 1-33 to implement aspects of facilitating user-proficiency in using radar gestures to interact with an electronic device.

The computing system 3400 includes communication devices 3402 that enable wired and/or wireless communication of device data 3404 (e.g., radar data, authentication data, reference data, received data, data that is being received, data scheduled for broadcast, and data packets of the data). The device data 3404 or other device content can include configuration settings of the device, media content stored on the device, and/or information associated with a user of the device (e.g., an identity of a person within a radar field or customized gesture data). Media content stored on the computing system 3400 can include any type of radar, biometric, audio, video, and/or image data. The computing system 3400 includes one or more data inputs 3406 via which any type of data, media content, and/or inputs can be received, such as human utterances, interactions with a radar field (e.g., a radar gesture), touch inputs, user-selectable inputs or interactions (explicit or implicit), messages, music, television media content, recorded video content, and any other type of audio, video, and/or image data received from any content and/or data source.

The computing system 3400 also includes communication interfaces 3408, which can be implemented as any one or more of a serial and/or a parallel interface, a wireless interface, any type of network interface, a modem, and as any other type of communication interface. The communication interfaces 3408 provide a connection and/or communication links between the computing system 3400 and a communication network by which other electronic, computing, and communication devices communicate data with the computing system 3400.

The computing system 3400 includes one or more processors 3410 (e.g., any of microprocessors, controllers, or other controllers) that can process various computer-executable instructions to control the operation of the computing system 3400 and to enable techniques for, or in which can be implemented, facilitating user-proficiency in using radar gestures to interact with an electronic device. Alternatively or additionally, the computing system 3400 can be implemented with any one or combination of hardware, firmware, or fixed logic circuitry that is implemented in connection with processing and control circuits, which are generally identified at 3412. Although not shown, the computing system 3400 can include a system bus or data transfer system that couples the various components within the device. The system bus can include any one or combination of different bus structures, such as a memory bus or memory controller, a peripheral bus, a universal serial bus, and/or a processor or local bus that utilizes any of a variety of bus architectures. Also not shown, the computing system 3400 can include one or more non-radar sensors, such as the non-radar sensors 108.

The computing system 3400 also includes computer-readable media 3414, such as one or more memory devices that enable persistent and/or non-transitory data storage (e.g., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. The computing system 3400 can also include a mass storage media device (storage media) 3416.

The computer-readable media 3414 provides data storage mechanisms to store the device data 3404, as well as various device applications 3418 and any other types of information and/or data related to operational aspects of the computing system 3400. For example, an operating system 3420 can be maintained as a computer application with the computer-readable media 3414 and executed on the processors 3410. The device applications 3418 may include a device manager, such as any form of a control application, software application, signal-processing and control modules, code that is native to a particular device, an abstraction module, a gesture recognition module, and/or other modules. The device applications 3418 may also include system components, engines, modules, or managers to implement aspects of facilitating user-proficiency in using radar gestures to interact with an electronic device, such as the radar system 104, the gesture-training module 106, the application manager 116, or the gesture library 120. The computing system 3400 may also include, or have access to, one or more machine-learning systems.

Although aspects of facilitating user-proficiency in using radar gestures to interact with an electronic device have been described in language specific to features and/or methods, the subject of the appended claims is not necessarily limited to the specific features or methods described. Rather, the specific features and methods are disclosed as example implementations of facilitating user-proficiency in using radar gestures to interact with an electronic device, and other equivalent features and methods are intended to be within the scope of the appended claims. Further, various and different aspects are described, and it is to be appreciated that each described aspect can be implemented independently or in connection with one or more other described aspects.

What is claimed is:

1. A method performed by a radar-gesture-enabled electronic device for facilitating user proficiency in using gestures received using radar, the facilitating through visual game-play, the method comprising:
presenting a first visual gaming element on a display of the radar-gesture-enabled electronic device;
receiving first radar data corresponding to a first movement of a user in a radar field provided by a radar system, the radar system included or associated with the radar-gesture-enabled electronic device;
determining, based on the first radar data, whether the first movement of the user in the radar field comprises a first radar gesture; and
in response to determining that the first movement of the user in the radar field comprises the first radar gesture, presenting a successful visual animation of the first visual gaming element, the successful visual animation of the first visual gaming element indicating a successful advance of the visual game-play; or
in response to determining that the first movement of the user in the radar field does not comprise the first radar gesture, presenting an unsuccessful visual animation of the first visual gaming element, the unsuccessful visual animation of the first visual element indicating a failure to advance the visual game-play.

2. The method of claim 1, further comprising:
in response to the determining that the first movement of the user in the radar field does not comprise the first radar gesture, receiving second radar data corresponding to a second movement of the user in the radar field;
determining, based on the second radar data, that the second movement of the user in the radar field comprises the first radar gesture; and
in response to determining that the second movement of the user in the radar field comprises the first radar gesture, presenting the successful visual animation of the first visual gaming element.

3. The method of claim 2, wherein the determining, based on the second radar data, whether the second movement of the user in the radar field comprises the first radar gesture further comprises:
using the second radar data to detect values of a set of parameters that are associated with the second movement of the user in the radar field;
comparing the detected values of the set of parameters to benchmark values for the set of parameters, the benchmark values corresponding to the first radar gesture.

4. The method of claim 2, further comprising:
in response to determining that the first movement or second movement of the user in the radar field comprises the first radar gesture, presenting a second visual gaming element;
receiving third radar data corresponding to a third movement of the user in the radar field, the third radar data received after the first radar data and the second radar data;
determining, based on the third radar data, that the third movement of the user in the radar field comprises a second radar gesture; and
in response to determining that the third movement of the user in the radar field comprises the second radar gesture, presenting a successful visual animation of the second visual gaming element, the successful visual animation of the second visual gaming element indicating another successful advance of the visual game-play.

5. The method of claim 4, wherein the determining, based on the third radar data, whether the third movement of the user in the radar field comprises the second radar gesture further comprises:
using the third radar data to detect values of a set of parameters that are associated with the third movement of the user in the radar field;
comparing the detected values of the set of parameters to benchmark values for the set of parameters, the benchmark values corresponding to the second radar gesture.

6. The method of claim 4, wherein a field of view within which the first radar gesture or the second radar gesture is determined includes a volumes within approximately one meter of the radar-gesture-enabled electronic device and within angles of greater than approximately ten degrees measured from the plane of a display of the radar-gesture-enabled electronic device.

7. The method of claim 4, further comprising:
generating, with a machine-learned model, adjusted benchmark values associated with the first radar gesture or the second radar gesture;
receiving fourth radar data corresponding to a fourth movement of the user in the radar field;
using the fourth radar data to detect values of a set of parameters that are associated with the fourth movement of the user in the radar field;
comparing the detected values of the set of parameters to the adjusted benchmark values;
determining, based on the comparison, that the fourth movement of the user in the radar field comprises the first or second radar gesture, and wherein the fourth movement of the user in the radar field is not the first or second radar gesture based on a comparison of the values of the set of parameters to default benchmark values.

8. The method of claim 1, wherein the determining, based on the first radar data, whether the first movement of the user in the radar field comprises the first radar gesture further comprises:
using the first radar data to detect values of a first set of parameters that are associated with the first movement of the user in the radar field;
comparing the detected values of the first set of parameters to first benchmark values for the first the set of parameters, the first benchmark values corresponding to the first radar gesture.

9. The method of claim 1, wherein the first visual gaming element is presented without textual instructions or non-textual instructions associated with how to perform the first radar gesture.

10. The method of claim 1, wherein the first visual gaming element is presented with a supplementary instruction that describes how to perform the first radar gesture.

11. A radar-gesture-enabled electronic device, comprising:
a computer processor;
a radar system, implemented at least partially in hardware, configured to:
provide a radar field;
sense reflections from a user in the radar field;
analyze the reflections from the user in the radar field; and
provide, based on the analysis of the reflections, radar data; and
a computer-readable media having instructions stored thereon that, responsive to execution by the computer processor, implement a gesture-training module configured to:
present, in context of visual game-play, a first visual gaming element on a display of the radar-gesture-enabled electronic device;
receive a first subset of the radar data corresponding to a first movement of the user in the radar field;
determining, based on the first subset of the radar data, whether the first movement of the user in the radar field comprises a first radar gesture;
in response to a determination that the first movement of the user in the radar field comprises the first radar gesture, present a successful visual animation of the first visual gaming element, the successful visual animation of the first visual gaming element indicating a successful advance of the visual game-play; or
in response to a determination that the first movement of the user in the radar field does not comprise the first radar gesture, present an unsuccessful visual animation of the first visual gaming element, the unsuccessful visual animation of the first visual element indicating a failure to advance the visual game-play.

12. The radar-gesture-enabled electronic device of claim 11, wherein the gesture-training module is further configured to:
in response to the determination that the first movement of the user in the radar field does not comprise the first radar gesture, receive a second subset of the radar data corresponding to a second movement of the user in the radar field;
determine, based on the second subset of the radar data, that the second movement of the user in the radar field comprises the first radar gesture; and
in response to the determination that the second movement of the user in the radar field comprises the first radar gesture, present the successful visual animation of the first visual gaming element.

13. The radar-gesture-enabled electronic device of claim 12, wherein the determination, based on the second subset of the radar data, that the second movement of the user in the radar field comprises the first radar gesture further comprises:
using the second radar data to detect values of a set of parameters that are associated with the second movement of the user in the radar field;
comparing the detected values of the set of parameters to benchmark values for the set of parameters, the benchmark values corresponding to the first radar gesture.

14. The radar-gesture-enabled electronic device of claim 12, wherein the gesture-training module is further configured to:
in response to the determination that the first movement or the second movement of the user in the radar field comprises the first radar gesture, present a second visual gaming element;
receive a third subset of the radar data corresponding to a third movement of the user in the radar field, the third subset of the radar data received after the first or second subsets of the radar data;
determine, based on the third subset of the radar data, that the third movement of the user in the radar field comprises a second radar gesture; and
in response to the determination that the third movement of the user in the radar field comprises the second radar gesture, present a successful visual animation of the second visual gaming element, the successful visual animation of the second visual gaming element indicating another successful advance of the visual game-play.

15. The radar-gesture-enabled electronic device of claim 14, wherein the determination, based on the third subset of the radar data, that the third movement of the user in the radar field comprises the second radar gesture further comprises:
using the third subset of radar data to detect values of a set of parameters that are associated with the third movement of the user in the radar field;
comparing the detected values of the set of parameters to benchmark values for the set of parameters, the benchmark values corresponding to the second radar gesture.

16. The radar-gesture-enabled electronic device of claim 14, wherein a field of view within which the first radar gesture or the second radar gesture is determined includes volumes within approximately one meter of the radar-gesture-enabled electronic device and within angles of greater than approximately ten degrees measured from a plane of the display of the radar-gesture-enabled electronic device.

17. The radar-gesture-enabled electronic device of claim 14, wherein the gesture-training module is further configured to:
generate, with a machine-learned model, adjusted benchmark values associated with the first radar gesture or the second radar gesture;
receive a fourth subset of the radar data corresponding to a fourth movement of the user in the radar field;
use the fourth subset of the radar data to detect values of a set of parameters that are associated with the fourth movement of the user in the radar field;
compare the detected values of the set of parameters to the adjusted benchmark values;
determine, based on the comparison, that the fourth movement of the user in the radar field comprises the first or second radar gesture, and wherein the fourth movement of the user in the radar field is not the first radar gesture or the second radar gesture based on a comparison of the values of the set of parameters to default benchmark values.

18. The radar-gesture-enabled electronic device of claim 11, wherein the determination, based on the first subset of the radar data, whether the first movement of the user in the radar field comprises the first radar gesture further comprises:
using the first subset of the radar data to detect values of a set of parameters that are associated with the first movement of the user in the radar field;
comparing the detected values of the set of parameters to benchmark values for the set of parameters, the benchmark values corresponding to the first radar gesture.

19. The radar-gesture-enabled electronic device of claim 11, wherein the first visual gaming element is presented without textual instructions or non-textual instructions associated with how to perform the first radar gesture.

20. The radar-gesture-enabled electronic device of claim 11, wherein the first visual gaming element is presented with a supplementary instruction that describes how to perform the first radar gesture, the supplementary instruction comprising either or both of textual instructions or non-textual instructions.
